(19) United States
(12) Patent Application Publication
(10) Pub. No.: US 2017/0039880 A1
(43) Pub. Date: Feb. 9, 2017

(54) TRAINING METHODS FOR IMPROVED ASSAYING OF CLINICAL SYMPTOMS IN CLINICAL TRIAL SUBJECTS

(71) Applicant: ANALGESIC SOLUTIONS, Natick, MA (US)

(72) Inventor: Nathaniel Katz, Natick, MA (US)

(21) Appl. No.: 15/304,461

(22) PCT Filed: Apr. 14, 2015
(86) PCT No.: PCT/US2015/025686

§ 371 Date: Oct. 14, 2016

Related U.S. Application Data
(60) Provisional application No. 61/980,451, filed on Apr. 16, 2014.

(51) Int. Cl. G09B 19/00; G06F 19/00

(52) U.S. Cl. CPC G09B 19/00; G06F 19/363

(57) ABSTRACT

Provided are methods for training subjects to report clinical symptoms (e.g., pain), and methods for identifying accurate clinical symptom (e.g., pain) reporting subjects prior to or subsequent to training.

### RELATED APPLICATION

This application claims the benefit of and claims priority to U.S. provisional application Ser. No. 61/980,451 filed Apr. 16, 2014, entitled, “Training Methods For Improved Assaying Of Clinical Symptoms In Clinical Trial Subjects”, which is incorporated by reference herein in its entirety.

### BACKGROUND OF THE INVENTION

Subject self-reporting (verbal or written) of pain levels is the source of virtually all important efficacy outcome data in clinical trials for analgesics. With the exception of physically observable changes such as blood pressure or pupil dilation, which are unsuitable primary measures of pain, researchers generally rely upon a subject's subjective self-reporting of their pain experience (Patient Reported Outcome, PRO). Thus, subject self-reporting of pain is an important contributor to treatment group differences and variation, both of which affect clinical trial sensitivity. Indeed, double-blind clinical trials for analgesics have often failed due to distorted or ‘noisy’ pain reports from subjects.

Much effort has gone into maximizing the assay sensitivity of clinical trials for potential analgesics. Increasing assay sensitivity has the obvious benefit of reducing sample size requirements for clinical trials, thus allowing the same information to be derived by experimentation on fewer human subjects. This, in turn, reduces cost and time to conduct the trial, and decreases the likelihood of false negative trials (i.e., when an efficacious analgesic fails to separate from placebo). To accurately discriminate between an effective analgesic compound and placebo, a clinical study requires adequate sensitivity and statistical power.

Calculations of statistical power involve two essential components: treatment group differences (difference in mean pain scores between each group) and variation of those pain scores. Many factors can contribute to each of these, such as a subject's pre-treatment characteristics, treatment dosage, study design factors, precision of outcome measures, and, of course, actual treatment efficacy. Researchers have explored practices and procedures to maximize treatment group differences and minimize variations, mainly by focusing their efforts on optimizing study designs and outcome measures. However, none of these optimizations have focused on the source of the data: the subjects themselves.

Pain is a subjective experience that is a function of both physical sensations and psychological processes. Therefore, for the same level of pain-producing physical stimuli (e.g., experimental pain, arthritic joint, bone metastasis, etc.), there may be important individual differences in the pain experience. When subjected to the same pain-producing stimulus, some subjects may report their pain levels reliably and precisely, while others may vary wildly in their reports of pain for the same experience. Importantly, individuals with large pain variation are more likely to respond to placebo or respond well to both the analgesic and the placebo. Such individuals not only introduce “noise” by the large degree of variation in their pain scores, but also decrease the ability of the trial to discriminate between treatment groups due to their greater tendency to experience spontaneous resolution or placebo responses in a clinical trial. Subjects with inconsistent pain reports also tend to continue to be inconsistent over time.

Much of the research concerned with subject pain reporting seeks to validate particular assessment scales, or the utility of one method of measurement relative to another. Other approaches are focused on statistical or methodological manipulation of pain reports, such as training people to make their reports relative to given anchor points (a method called “Constrained Scaling”) or constructing scales that adapt to individual reporters' biases and nuances (an approach termed “Master Scaling”). However, these procedures are too cumbersome or impractical for implementation in clinical trials. Moreover, it is unlikely that one single scale takes into account all factors associated with pain reporting reliability or lack thereof.

Accordingly, there is a need in the art for improved methods of assaying pain reporting subjects, especially methods that can identify accurate pain reporting subjects.

### SUMMARY OF THE INVENTION

The present invention provides methods for training subjects to report clinical symptoms (e.g., pain), and for identifying accurate clinical symptom (e.g., pain) reporting subjects prior to or subsequent to training. The methods of the invention can be used to improve the accuracy of clinical symptom (e.g., pain) reporting of subjects having any condition that exhibits a measurable clinical symptom. Such methods are particularly useful for improving the accuracy of pain reporting of subjects and also allow for identification of those subjects that are accurate pain reporters. The methods of the invention are especially useful in clinical trials of analgesics where the training and selection of accurate pain reporting subjects improves the statistical power and accuracy of the clinical trial results.

Accordingly, in one aspect the invention provides a method of training a subject to accurately report a clinical symptom, the method comprising: a) administering to a subject exhibiting a clinical symptom a drug suitable for treating the clinical symptom or a placebo, wherein the drug is administered in an amount sufficient to alleviate the clinical symptom; b) determining the intensity of the clinical symptom reported by the subject before and after administration of the drug or the placebo using a standard reporting scale; c) determining the symptom reporting accuracy of the subject in the presence of the drug or placebo and providing instructional feedback to the subject regarding the accuracy and reliability of their reporting; and d) repeating steps (a) to (c) one or more times, wherein on each occasion the subject is administered drug or placebo in a random and double-blind manner.

In certain embodiments, step (d) is repeated until a desired reporting accuracy is achieved. In certain embodiments, steps (a) to (c) are repeated four times at weekly intervals. In certain embodiments, steps (a) to (c) are performed for 4 hours and the subject evaluated hourly for clinical symptom relief. In certain embodiments, steps (a) to (c) are performed for at least about four hours, at least about 8 hours or at least about 12 hours.

In certain embodiments, the method further comprises identifying an accurate symptom reporting subject, wherein an accurate symptom reporting subject is identified by having a symptom reporting accuracy and/or reliability above a desired threshold.

In certain embodiments, the clinical symptom is pain, anxiety, asthma, or urinary frequency. In certain embodiments, the pain is Painful Diabetic Neuropathy (PDN). In certain embodiments, the drug is an analgesic (e.g., oxycodone or pregabalin).

In another aspect, the invention provides a method of training a subject to accurately report a clinical symptom, the method comprising: a) inducing a clinical symptom in the subject; b) determining the intensity of the clinical symptom reported by the subject using a standard reporting scale; c) determining the symptom reporting accuracy of the subject and providing instructional feedback to the subject regarding the accuracy and reliability of their reporting; and d) repeating steps (a) to (c) one or more times.

In certain embodiments, step (d) is repeated until a desired reporting accuracy is achieved.

In certain embodiments, the method further comprises identifying an accurate symptom reporting subject, wherein an accurate symptom reporting subject is identified by having a symptom reporting accuracy and/or reliability above a desired threshold.

In certain embodiments, the clinical symptom is pain, anxiety, asthma, or urinary frequency. In certain embodiments, the pain is Painful Diabetic Neuropathy (PDN).

In another aspect, the invention provides a method of training a subject to accurately report a clinical symptom, the method comprising: a) determining the reported pain threshold and tolerance levels of the subject in response to an evoked pain stimulus; b) determining the response profile of the subject to noxious stimuli using a standard pain reporting scale in the presence of an analgesic or a placebo, wherein the noxious stimuli intensity are between the pain threshold and tolerance levels of the subject, and wherein the analgesic is administered in an amount sufficient to alleviate the pain induced by the noxious stimuli; c) determining the pain reporting accuracy and/or reliability of the subject by analysis of the data collected in (a) and (b); d) providing instructional feedback to the subject regarding the accuracy and reliability of their pain reporting; and e) repeating steps (a) to (e) one or more times, wherein on each occasion the subject is administered the analgesic or the placebo in a random and double-blind manner.

In certain embodiments, step (e) is repeated until a desired reporting accuracy is achieved.

In certain embodiments, the method further comprises identifying an accurate symptom reporting subject, wherein an accurate symptom reporting subject is identified by having a symptom reporting accuracy and/or reliability above a desired threshold.

In certain embodiments, the clinical symptom is pain, anxiety, asthma, or urinary frequency. In certain embodiments, the pain is PDN. In certain embodiments, the drug is an analgesic (e.g., oxycodone or pregabalin).

In certain embodiments of the methods disclosed herein, the pain threshold and tolerance levels of the subject are determined in response to a mechanical pressure or thermal stimulus.

In certain embodiments of the methods disclosed herein, the noxious stimuli include mechanical pressure or thermal stimuli.

In certain embodiments of the methods disclosed herein, the noxious stimuli are applied in a random order of intensity.

In certain embodiments of the methods disclosed herein, the noxious stimuli are applied in discreet interval levels, evenly spaced between the subject's threshold and tolerance levels. In one particular embodiment, the noxious stimuli are applied in 5 to 9 interval levels. In another particular embodiment, each interval level of noxious stimuli is applied between 3 and 7 times to the subject during a single session.

In certain embodiments of the methods disclosed herein, the standard pain reporting scale is a numerical rating scale (NRS) or visual analog scale (VAS).

In certain embodiments of the methods disclosed herein, the pain reporting accuracy and/or reliability of the subject is determined using a the Coefficient of Variation, Intraclass Correlation Coefficient, R² curve fit statistic from a least squares fit to psychophysical function, and/or the Residual between the predicted and actual pain ratings using a ‘triangulation’ method.

In certain embodiments of the methods disclosed herein, an accurate pain reporting subject is identified by having a Coefficient of Variation of less than 1, an Intraclass Correlation Coefficient of greater than 0.8, an R² of greater than 0.5, and/or a triangulation residual of less than 20% of the range of the response scale being used.

### BRIEF DESCRIPTION OF THE DRAWINGS

FIG. 1 depicts an example of a psychophysical subject profile, plotting the reported pain intensity against the applied pressure stimulus.

FIG. 2 depicts a plot of the consistency of pain reporting of a subject quantified by the residual between the point where index pain standard scale and Pain Match ratings intersect, and a vertical line dropped to the psychophysical function.

FIG. 3 illustrates the study design of the clinical study exemplified herein. Participants will not be allowed to use oral NSAIDs or other oral analgesics (aside from study drugs); nor will they be allowed to use topical medications during the study; nor will they be allowed to undergo any other treatments intended to reduce their PDN pain (e.g., surgical procedures, acupuncture, electrical stimulation, etc.). Acetaminophen will be allowed as rescue medication (as needed up to 2 g/day); participants will be reminded not to take acetaminophen at least 12 hours before each in-clinic visit. Participants will be encouraged to maintain their customary level of physical activity during the study.

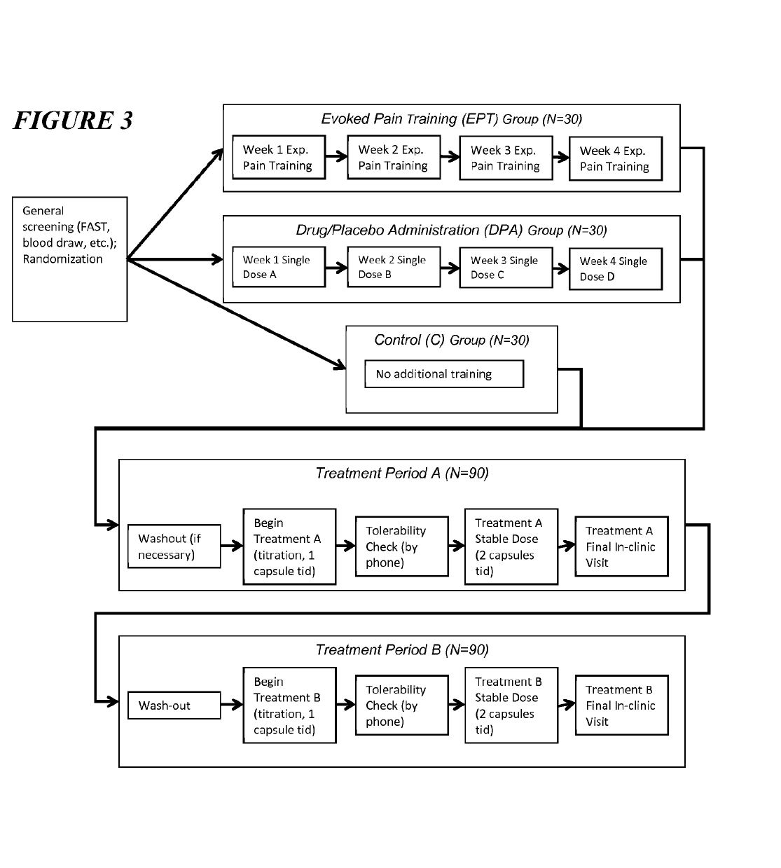

### DETAILED DESCRIPTION

### I. Definitions

As used herein, the term “natural index pain” or “index pain” refers to the natural pain perceived by a subject as a result of a disease/disorder, injury and/or surgical procedure. Exemplary index pain includes, without limitation, knee pain from osteoarthritis.

### Clinical Symptom Reporting Training Overview

The present invention provides methods of training a subject to more accurately report the clinical symptoms of a condition. The reporting of any clinical symptom that can be sensed by a subject can be trained using the methods of the invention, including without limitation, pain, migraine, urinary frequency, asthma, and anxiety. In certain embodiments, the clinical symptom is pain (e.g., Painful Diabetic Neuropathy).

In certain embodiments, the methods of the invention involve Drug/Placebo Administration to increase the participants' ability to discriminate between active and placebo treatments. The Drug/Placebo Administration generally involves administering to a patient a drug or placebo in a randomized, double-blind manner. The subject's responses are collected and analyzed for their consistency and reliability (e.g. determining whether a subject reports the expected reduction in severity of a clinical symptom when given a suitable drug). Subjects are provided with feedback and undergo multiple cycles of evaluation and feedback to improve their ability to reliably report their clinical symptom. This skill improves the quality of data the subject can provide in a clinical trial without biasing them towards a positive or negative response to a treatment, thereby improving trial sensitivity and power.

In certain embodiments, the invention provides a method of training a subject to accurately report the effects of a drug on a clinical symptom that involves Drug/Placebo Administration. The method generally comprises: a) administering to a subject exhibiting a clinical symptom a drug suitable for treating the clinical symptom or a placebo, wherein the drug is administered in an amount sufficient to alleviate the clinical symptom; b) determining the intensity of the clinical symptom reported by the subject before and after administration of the drug or the placebo using a standard reporting scale; c) determining the symptom reporting accuracy of the subject in the presence of the drug or placebo and providing instructional feedback to the subject regarding the accuracy and reliability of their reporting; and d) repeating steps (a) to (c) one or more times, wherein on each occasion the subject is administered drug or placebo in a random and double-blind manner.

In this method, step (d) can be repeated until a desired reporting accuracy is achieved (e.g., 1, 2, 3, 4, 5, 6, 7, 8, 9, 10, or more times). Steps (a) to (c) can be performed at any interval necessary to achieve a desired reporting accuracy (e.g., multiple times daily; 1, 2 3, 4, 5, 6, or 7 times per week; every 2 weeks; every 3 weeks; every month; every 2, 3, 4, 5, 6, 7, 8, 9, 10, 11 or 12 months). In one embodiment, steps (a) to (c) are repeated four times at weekly intervals.

Steps (a) to (c) can also be performed for any continuous duration necessary to achieve a desired reporting accuracy (e.g., for about 5, 10, 15, 20, 25, 30, 35, 40, 45, 50, 55, or 60 minutes; e.g., for about 1, 2, 3, 4, 5, 6, 7, 8, 9, 10, 11, 12 or more hours). The subject can be evaluated for clinical symptom relief at any interval (e.g., about every 5, 10, 15, 20, 25, 30, 35, 40, 45, 50, 55, or 60 minutes; e.g., about every 1, 2, 3, 4, 5, 6, 7, 8, 9, 10, 11, 12 or more hours). In one embodiment, steps (a) to (c) are performed for 4 hours and the subject is evaluated hourly for clinical symptom relief.

In certain embodiments, the clinical symptom is naturally exhibited by the subject. In certain embodiments, the clinical symptom is induced in the subject by an exogenous stimulus. For example, for reporting of migraine severity, a migraine can be induced in a subject, for example, by injection of histamine or some other migraine trigger, and symptoms reported using a standard scale. For reporting of urinary frequency, a subject can be administered, for example, oral water, and symptoms reported using a standard scale. For reporting of asthma severity, a subject can, for example, exercise or be subjected to some other asthma-inducing stimulus, and symptoms reported using a standard scale. For reporting of anxiety severity, a subject can, for example, read a scary story or watch a scary video, and anxiety levels reported using a standard scale.

Accordingly, in certain embodiments, the invention provide a method of training a subject to accurately report a clinical symptom, the method comprising: a) inducing a clinical symptom in the subject; b) determining the intensity of the clinical symptom reported by the subject using a standard reporting scale; c) determining the symptom reporting accuracy of the subject and providing instructional feedback to the subject regarding the accuracy and reliability of their reporting; and d) repeating steps (a) to (c) one or more times. Step (d) can be repeated until a desired reporting accuracy is achieved.

In certain embodiments, the methods of the invention involve Evoked Pain Training. Evoked Pain Training is a technique by which potential subjects for a clinical trial are trained on the use of pain reporting scales and attention to their personal pain states by repeated exposures to evoked pain stimuli and report of their pain experiences. Subjects are provided with feedback on their performance and undergo multiple cycles of training and performance that is quantified on multiple axes. The technique can be used until a performance criterion is met or for a fixed training period.

In certain embodiments, subjects are given a series of evoked pain stimuli in random order of intensity and asked to rate the intensity of the stimuli on a pain rating scale. The subject's responses are collected and analyzed for their consistency and reliability (e.g. for a stimuli of objective intensity X does the subject always report the subjective experience of Y, or a range from Y to Z?). Subjects additionally provide ratings of a naturalistic pain state or “index pain” (e.g. their pain from a chronic condition such as osteoarthritis or an acute pain such as from an injury) using the same rating scale and in terms of the evoked stimuli by means of cross-modality matching. Subjects are provided with feedback and undergo multiple cycles of evaluation and feedback to improve their ability to reliably report their pain states. This skill improves the quality of data the subject can provide in a clinical trial without biasing them towards a positive or negative response to a treatment, thereby improving trial sensitivity and power.

Accordingly, in certain embodiments, the invention provide a method of training a subject to report pain comprising: a) determining the reported pain threshold and tolerance levels of the subject in response to an evoked pain stimulus; b) determining the reported pain of the subject in response to a natural index pain using a standard pain reporting scale; c) determining the response profile of the subject to noxious stimuli using a standard pain reporting scale, wherein the noxious stimuli intensity are between the pain threshold and tolerance levels of the subject; d) determining the pain reporting accuracy and/or reliability of the subject by analysis of the data collected in (a), (b), and (c); e) providing instructional feedback to the subject regarding the accuracy and reliability of their pain reporting; and f) repeating steps (a) to (e) one or more times. Step (f) can be repeated until a desired reporting accuracy is achieved.

In certain embodiments, the methods of the invention involve a combination of Evoked Pain Training and Drug/Placebo Administration. Specifically, the invention provides a method of training a subject to accurately report a clinical symptom, the method comprising: a) determining the reported pain threshold and tolerance levels of the subject in response to an evoked pain stimulus; b) determining the response profile of the subject to noxious stimuli using a standard pain reporting scale in the presence of an analgesic or a placebo, wherein the noxious stimuli intensity are between the pain threshold and tolerance levels of the subject, and wherein the analgesic is administered in an amount sufficient to alleviate the pain induced by the noxious stimuli; c) determining the pain reporting accuracy and/or reliability of the subject by analysis of the data collected in (a) and (b); d) providing instructional feedback to the subject regarding the accuracy and reliability of their pain reporting; and e) repeating steps (a) to (e) one or more times, wherein on each occasion the subject is administered the analgesic or the placebo in a random and double-blind manner. Step (e) is repeated until a desired reporting accuracy is achieved.

The methods of clinical symptom reporting training disclosed herein can be used to train all subjects in a clinical trial to be better reporters. Additionally or alternatively, the disclosed methods can be used to distinguish accurate reporting subjects from inaccurate reporting subjects. The inaccurate reporting subjects can then be excluded from a clinical trial to improve the accuracy of the overall trial results.

### III. Baseline Evaluation

In certain embodiments, subjects are evaluated on their baseline ability to report evoked pain states accurately and use pain reporting scales consistently between evoked pain and clinical pain. In a preferred embodiment, this baseline evaluation is performed at the beginning of each training session.

Firstly, the subject's threshold and tolerance level for evoked pain stimuli is established. This can be done using any art-recognized methods. In a preferred embodiment, this is done by an ascending method of limits procedure in which the intensity of the stimulus is increased, either constantly or incrementally, until the subject reports that the stimulus has become painful. This is the threshold or lower bound. The stimulus is further increased until the subject reports that they cannot endure or tolerate any further increase. This is the tolerance or upper bound.

Secondly, the subject provides ratings of a natural index pain, such as their current pain from a chronic condition such as osteoarthritis or current pain from a recent surgical procedure or injury. Subjects rate this index pain on a standard scale (e.g. NRS) using Pain Matching. Pain Matching is accomplished by asking the subject to signal when a noxious stimulus (evoked pain) matches the intensity of their natural index pain. This can be done using any art-recognized methods. In a preferred embodiment, this is accomplished using a standard technique such as a staircase procedure, a method of limits, or method of adjustment. In the “staircase procedure” a stimulus is administered and the subject indicates if their index pain is more or less than the stimulus. The stimulus is then increased or decreased by an increment and assessed again. The increment is progressively narrowed until a minimum interval is reach. In the “method of limits” procedure there is a progressive increase of stimulus intensity from below threshold until the participant indicates a match (ascending method of limits) or a progressive decrease of stimulus intensity from above threshold until the participant indicates a match (descending method of limits). The “method of adjustment” procedure is similar to “method of limits”; however, the participant is allowed direct control of the stimulus intensity and can adjust it upward or downwards until it matches their natural index pain.

Thirdly, the subject undergoes a cycle of magnitude estimations of evoked pain stimuli between threshold and tolerance. Stimulus intervals are established, distributed between threshold and tolerance levels. The number of intervals may vary. In certain embodiments, the intervals are between 1 and 10, (e.g., between 5 and 9). Each level of stimulus is then administered multiple times. In certain embodiments, the varying each level of stimulus is administered between 1 and 10 times (e.g., between 3 and 7 times), in random order. The intervals and number of repetitions of each level may vary between programs based on the needs of the population. In certain embodiments, the intervals and number of repetitions of each level are fixed at or before the beginning of the training. For example, for a highly sensitive population such as subjects with fibromyalgia, a small number such as 5 intervals with only 3 repetitions for a total of 15 trials may be used, while a more robust population such as post-appendectomy patients may use 7 intervals and 7 repetitions for a total of 49 stimuli per cycle. Subjects provide a rating of the intensity of pain at each stimulus using a specified pain rating scale (e.g. NRS).

In certain embodiments, each evoked pain stimulus has a definable rate of increase and decrease (ramp) and a fixed peak duration. Subjects are instructed to rate the peak intensity of the stimulus. In certain embodiments, a minimum inter-stimulus interval between trials is fixed (this can dependent on stimulus modality, e.g., longer refractory periods may be required between thermal stimuli than electrical stimuli).

### IV. Subject Response Analyses

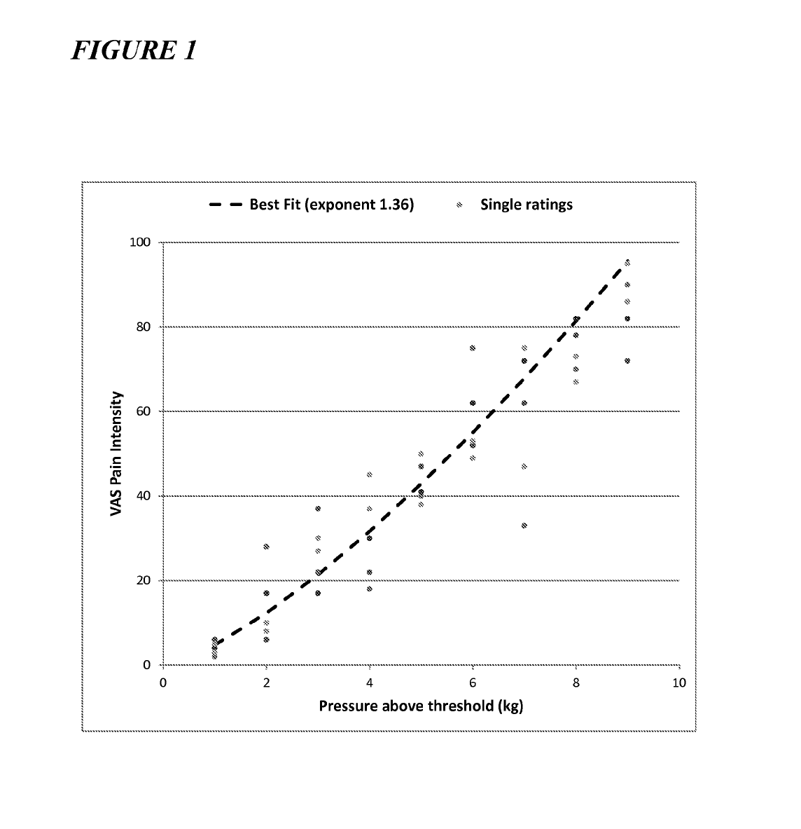

In general, a subject's threshold and tolerance for the evoked pain stimuli is analyzed as follows. Standard deviation of threshold, tolerance, and range are examined across training session to quantify stability over time using coefficients of variation (CoV), which is computed as standard deviation divided by mean. A subject's magnitude estimations are then used to compute a psychophysical profile (an exemplary psychophysical profile is depicted in FIG. 1). Data are centered and least-squares curve fitting is applied.

### Centering Data

Calculation of psychophysical function curves requires that ratings begin at threshold (or lower bound). Therefore, if a subject consistently rates the lowest stimulus at zero intensity the entire data set must be shifted (aka ‘left-censored’ or ‘centered’). This is accomplished by subtracting the highest stimulus intensity level at which pain of zero is reported from the objective stimulus quantification such that the first stimulus level is always 1. For example, a subject reporting thermal stimuli at intervals of 1 degree Celsius from 45 to 50 degrees reports zero pain at 45 and 46 degrees, and would be beginning to report pain only at 47 degrees C. The stimulus intensity for the data going into curve fitting becomes degrees C. minus 46. This is done to avoid a ‘tail’ to the data and shifting of the curve fit to accommodate sub-threshold stimuli.

Any device calibration or response scaling required by the device being used may be performed at this stage. For example, if the response scale is a 0-10 but the recording device reports 0-100 this conversion can be conducted simultaneously with data centering.

### Curve Fitting

Centered data are then fit to a least squares curve fit model. The least squares curve fitting is done using the following equation form:

$$Y = {Ax}^{B} where$$

$$b = \frac{n {\sum }_{i = 1}^{n} ( ln {x}_{j} ln {y}_{j} ) - {\sum }_{i = 1}^{n} ( ln {x}_{i} ) {\sum ( l \text{?}}_{j = 1}^{n}}{n {\sum }_{j = 1}^{n} {( ln {x}_{i} )}^{2} - {\sum }_{j = 1}^{n} {( ln {x}_{i} )}^{2}}$$

$$a = \frac{{\sum }_{i = 1}^{n} ( ln {y}_{i} ) - b {\sum }_{i = 1}^{n} ( ln {x}_{i} )}{n} , \\ B = b and A = {e}^{α} . \\ \text{?} \text{indicates text missing or illegible when filed}$$

### Triangulation

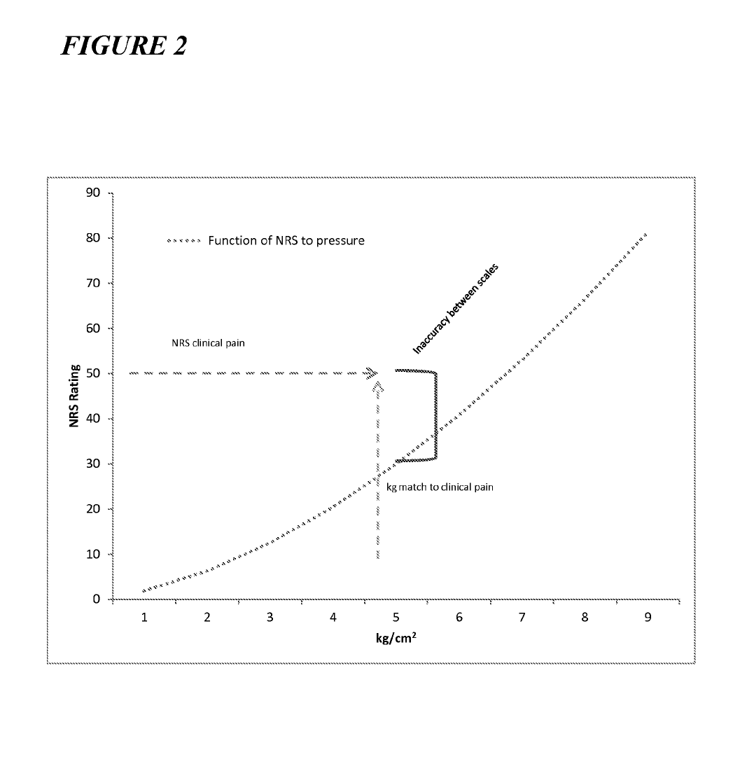

Comparison is made of how consistently a subject uses a response scale using a method called “triangulation”. By providing a standard scale rating of index pain, a stimulus matched rating of the same index pain and a standard scale rating of evoked stimuli, the subject has given three ratings that should theoretically converge. For example, using NRS ratings and pressure pain, a subject could report their index pain as 5 out of 10 (moderate pain) and match their index pain to a pressure intensity of 3 kg (saying 3 kg pressure causes pain equivalent to their index pain), but when rating the intensity of 3 kg of pressure on a 0-10 NRS they give an average rating of only 2. Such a result would indicate an inconsistency in scale use by the subject, because, according to the psychophysical profile established by the subject's rating of blinded stimuli, 3 kg of pressure was not as painful as their rated index pain. This is illustrated for example in FIG. 2 and is quantified by the residual between the point where index pain standard scale and Pain Match ratings intersect and a vertical line dropped to the psychophysical function. For example, if a subject rates their index pain at 6/10, Pain Matches the index pain to pressure at 4 kg, and the psychophysical function indicates that 4 kg of pressure are rated at 3.5, the residual (inconsistency between scale use) would be 2.5 (i.e., subject's index pain 6 minus indicated value of 3.5).

### Quantification of Report Reliability

Report reliability within an assessment cycle is quantified by: 1) average Coefficient of Variation (CoV) where CoV is calculated for each non-zero stimulus level and averaged; 2) R² fit to the least squares model; 3) average Intraclass Correlation Coefficient (ICC) calculated from all non-zero stimulus levels; and 4) the triangulation residual.

### V. Training Feedback

In certain embodiments, after baseline evaluation, subjects receive training feedback based upon their performance. Feedback can be given using any method, including without limitation, written or oral methods.

In a particular embodiment, data figures analogous to FIGS. 1 and 2, herein, are generated from the subject's actual reporting data and shown to them, along with idealized samples to illustrate accurate and inaccurate scale use. The data are reviewed with the subject by the trainer conducting the session and their attention is called to areas of high variability and/or inconsistency. For example, a subject is shown where a thermal stimulus (e.g., a 48° stimulus) was inaccurately rated as more painful than a cooler stimulus (e.g., a 46° stimulus). The subject is further instructed to pay attention to their pain state, keep in mind how they have used the scales previously, and try to be consistent. Such feedback is provided after each training cycle.

In the case of Drug/Placebo Administration, the patient is informed whether they received active drug or placebo after they have rated they intensity of the symptom (e.g., clinical pain).

### VI. Training Cycles and Session Scheduling

The number of training cycles conducted in a single session and the total number of sessions conducted may vary between training programs. At least 2 cycles of evaluation with feedback must be completed (one for baseline and a second to establish any change), but more may be conducted as desired. In certain embodiments, training sessions are separated by a minimum of about 2 days and a maximum of about 14 days (e.g., about 3, 4, 5, 6, 7, 8, 9, 10, 11, 12 or 13 days).

In certain embodiments, training cycles are not separated by more than 1 hour within a session. Sessions can be repeated as necessary until a minimum performance criterion is met (e.g. until subject's triangulation residual is <2 and R² is >0.9) or for a pre-specified number of sessions (e.g. 4 weekly sessions on consecutive weeks prior to study enrollment) depending on desired use.

The number of training cycles within a session may also be varied according to the burden and demands of the target population. For example, a generally young and vigorous post-surgical subject may have a narrow window of opportunity but high tolerance for training (e.g., 2 sessions 3 days apart, each session containing 4 training cycles) whereas a highly sensitive elderly subject with chronic pain may have as many sessions as necessary to meet performance criterion (e.g., sessions scheduled weekly and only containing 1 training cycle per session).

### VII. Methods of Identifying an Accurate Clinical Symptom Reporting Subject

In another aspect, the present invention provides methods of identifying an accurate clinical symptom (e.g., pain) reporting subject.

In certain embodiments, the method comprises: a) administering to a subject exhibiting a clinical symptom a drug suitable for treating the clinical symptom or a placebo; b) determining the intensity of the clinical symptom reported by the subject before and after administration of the drug or the placebo using a standard reporting scale; c) determining the symptom reporting accuracy of the subject in the presence of the drug or placebo and providing instructional feedback to the subject regarding the accuracy and reliability of their reporting; d) repeating steps (a) to (c) one or more times, wherein on each occasion the subject is administered drug or placebo in a random and double-blind manner; and e) identifying an accurate symptom reporting subject, wherein an accurate symptom reporting subject is identified by having a symptom reporting accuracy and/or reliability above a desired threshold.

In certain embodiments, the method comprises: a) inducing a clinical symptom in the subject; b) determining the intensity of the clinical symptom reported by the subject using a standard reporting scale; c) determining the symptom reporting accuracy of the subject and providing instructional feedback to the subject regarding the accuracy and reliability of their reporting; d) repeating steps (a) to (c) one or more times; and e) identifying an accurate symptom reporting subject, wherein an accurate symptom reporting subject is identified by having a symptom reporting accuracy and/or reliability above a desired threshold.

In certain embodiments, the method comprises: a) determining the reported pain threshold and tolerance levels of the subject in response to an evoked pain stimulus; b) determining the response profile of the subject to noxious stimuli using a standard pain reporting scale in the presence of an analgesic or a placebo, wherein the noxious stimuli intensity are between the pain threshold and tolerance levels of the subject; c) determining the pain reporting accuracy and/or reliability of the subject by analysis of the data collected in (a) and (b); d) providing instructional feedback to the subject regarding the accuracy and reliability of their pain reporting; e) repeating steps (a) to (e) one or more times, wherein on each occasion the subject is administered the analgesic or the placebo in a random and double-blind manner; and f) identifying an accurate symptom reporting subject, wherein an accurate symptom reporting subject is identified by having a symptom reporting accuracy and/or reliability above a desired threshold. In one embodiment, the an accurate symptom reporting subject is identified by having a Coefficient of Variation of less than 1, an Intraclass Correlation Coefficient of greater than 0.8, an R² of greater than 0.5, and/or a triangulation residual of less than 20% of the range of the response scale being used.

Any art-recognized method of quantification and analysis of the reported pain of the subject can be employed. In certain embodiments, the accuracy of the subject's pain reporting accuracy is determined using the Coefficient of Variation (see e.g., Reed, J. F., Lynn, F., & Meade, B. D. (2002) Use of coefficient of variation in assessing variability of quantitative assays. Clin Diagn Lab Immuno. 9(6), 1235-1239, which is incorporated herein by reference in its entirety). In a particular embodiment, a Coefficient of Variation of less than 1 (e.g., about 0.9. 0.8, 0.7, 0.6, 0.5, 0.4, 0.3, 0.2, or 0.1) identifies a subject as an accurate pain reporter.

In certain embodiments, the accuracy of the subject's pain reporting accuracy is determined using the Intraclass Correlation Coefficient (see e. g., Shrout, P. E., & Fleiss, J. L. (1979) Intraclass correlations: Uses in assessing rater reliability. Psychological Bulletin, 86, 420-428, which is incorporated herein by reference in its entirety). In a particular embodiment, an Intraclass Correlation Coefficient of greater than 0.95 (e.g., about 0.96. 0.97, 0.98, or 0.99) identifies a subject as an accurate pain reporter.

In certain embodiments, the accuracy of the subject's pain reporting accuracy is determined using an R² curve fit statistic from a least squares fit to psychophysical function (power law) (see e.g., Stevens, S. S. (1961) The psychophysics of sensory function. In Rosenblith, W. A. (ed.) Sensory Communications, 1-33, which is incorporated herein by reference in its entirety). In a particular embodiment, an R² of greater than 0.5 (e.g., about 0.6. 0.7, 0.8, 0.9, or 1.0) identifies a subject as an accurate pain reporter.

In certain embodiments, the accuracy of the subject's pain reporting accuracy is determined using the Residual between predicted and actual pain ratings using a ‘triangulation’ method (see e.g., Gracely, R, & Kwilosz, D. M. (1988). The Descriptor Differential Scale: Applying psychophysical principles to clinical pain assessment. Pain, 35, 279-288; and Doctor, J. N., Slater, M. A., & Atkinson, J. H. (1995). The descriptor differential scale of pain intensity: An evaluation of item and scale properties. Pain, 61, 251-260, both which is incorporated herein by reference in their entirety). In a particular embodiment, a triangulation residual of less than 15% (e.g., about 14, 13, 12, 11, 10, 9, 8, 7, 6, 5, 4, 3, 2, or 1%) of the response scale being used (e.g. less than 15 if a 0-100 mm VAS is used as the standard response scale) identifies a subject as an accurate pain reporter.

### VIII. Rating Scales

The methods disclosed herein can use any art-recognized rating scale or measures. For pain reporting, suitable scales include, without limitation, standard numerical rating scales (NRS) or visual analog scales (VAS), and any quantitative pain report method, including measures of specific aspects of pain (e.g. the McGill Pain Questionnaire item for intensity of burning pain specifically).

### IX. Evoked Pain Modality

Any evoked pain modality can be used in the methods disclosed herein. In certain embodiments, evoked pain is applied to the subject using a device that can, via mechanical or electronic control, reliably exert a variable intensity stimulus of a noxious nature within a range that is both painful and safe. Examples of painful modalities include, but are not limited to, heat, cold, pressure, electrical stimulation, chemical (e.g. capsaicin), ischemic, or visceral pain. Suitable common devices include the Medoc TSA-II neurosensory analyzer (Medoc, Israel), which can apply controlled heat stimuli via a thermode in contact with the skin or the Multimodal Automated Sensory Testing (MAST, UMich), which can apply calibrated pressure stimuli to the thumbnail. In a preferred embodiment, the device is capable of delivering repeated stimuli at fixed levels without variable intervention of a human agent (e.g. a hand-held dolorimeter with pressure exerted by a human operator would be unacceptable). In a preferred embodiment, the device is capable of exerting sufficient stimulus intensity to exceed pain thresholds for subjects but not so much as to cause potential injury. In a preferred embodiment, the device has acceptable safety functions in place such that a subject may terminate any stimulus at any time.

### X. Drug/Placebo

Any drug can be used in the methods disclosed herein, so long as the drug reduces the severity of a clinical symptom. Suitable drugs types include, without limitation, analgesic, anti-asthmatic, and anti-anxiety drugs. In certain embodiments, the drug is oxycodone or pregabalin. Any placebo can be used in the methods disclosed herein.

### XI. Exemplification

The ability of Evoked Pain Training (EPT) and Drug/Placebo Administration (DPA) training to increase participants' ability to discriminate between active and placebo treatments in a clinical trial was determined in a randomized, double-blind crossover trial of a known analgesic, as measured by standardized effect size, relative to untrained control participants.

TABLE 1
Protocol Abbreviations/Acronyms

| Abbreviation/ | |
|---|---|
| Acronym | Definition |
| AE | Adverse event |
| ALT | Alanine aminotransferase |
| ANOVA | Analysis of variance |
| AST | Aspartate aminotransferase |
| CFR | Code of Federal Regulations |
| CoV | Coefficient of variation |
| CRF | Case report form |
| DPA | Drug/Placebo Administration |
| EPT | Evoked Pain Training |
| FAST | Focused Analgesia Selection Task |
| FDA | U.S. Food and Drug Administration |
| HADS | Hospital Anxiety and Depression Scale |
| ICC | Intraclass correlation coefficient |
| ICF | Informed consent form |
| IRB | Institutional Review Board |
| ISI | Interstimulus Interval |
| MAST | Multimodal Automated Sensory Testing |
| NRS | 0-10 numerical rating scale with anchors of “no pain” |
| | and “extreme pain” |
| NSAID | Nonsteroidal anti-inflammatory drug |
| OA | Osteoarthritis |
| PDN | Painful Diabetic Neuropathy |
| PGIC | Patient Global Impression of Change |
| PPT | Pressure pain threshold |
| SAE | Serious adverse event |
| SES | Standardized effect size |
| VAS | Visual Analog Scale |

### Study Design Rationale

1.1.1. General Design Rationale

The study is divided into two distinct stages. The first stage, termed the Training stage, is a non-blinded, randomized parallel design in which participants will be randomized to one of three training conditions: EPT, DPA, or Control (C) (no special training). In this stage, participants and study staff will necessarily know which training group the participants are assigned to. Participants will also be aware of what the other training conditions are, as they must be fully informed of all possible conditions they might be assigned to prior to consent. The design is parallel in order to clearly distinguish the effect, if any, each training has without contamination or carry-over effects from another condition. Within the DPA training arm participants will undergo a double-blind, randomized, 4-period crossover treatment wherein they receive 2 doses of placebo, 1 dose of oxycodone, and 1 dose of pregabalin in a series of single-dose in-clinic visits. The order of treatments will be randomized, but the participant will be unblinded after each dose (detailed below) for training purposes.

The second stage, Training Evaluation stage, is a double-blinded, placebo-controlled, randomized, 2-period crossover study. Randomization will be used to minimize bias in the assignment of participants to treatment sequences and to increase the likelihood that known and unknown subject attributes (e.g., demographic and baseline characteristics) are evenly balanced across treatment sequences. Blinded treatment will be used to reduce potential bias during data collection and evaluation of clinical endpoints. The crossover design is being used (i) to minimize subject variability (with each subject being used as his/her own control), and (ii) to minimize the number of participants needed for evaluations.

1.1.2. Treatments

### Study Medications

A placebo is being used in order to establish the magnitude of changes in clinical endpoints that may occur in the absence of an active treatment and provide an adequate control for evaluating analgesic effect.

Pregabalin, an analgesic known to be effective in treating painful diabetic neuropathy (PDN) (Lesser et al. 2004, Rosenstock et al. 2004, Richter et al. 2005), was chosen in order to evaluate the relative magnitude of any differences in the ability to detect a true analgesic effect. If an active treatment of unknown efficacy for the indication were used, we would have no way of knowing if a lack of difference were due to training having no effect or the treatment having no true effect. Oxycodone was chosen as one of the treatments during DPA training because it is a commonly used prescription analgesic with known efficacy and has a different side-effect profile than does pregabalin.

### Treatment Duration

Total treatment duration of 10 days was chosen as the minimum duration necessary to demonstrate efficacy. This includes a 3-4 day titration period and 1 week of stable dose. Previous studies have shown efficacy of pregabalin at 1 week (Lesser et al. 2004, Rosenstock et al. 2004). No taper period is considered necessary due to the short duration of treatment and exclusion of patients with seizure disorders minimizing any adverse reaction to discontinuation. Since the primary motivation of the study is to test methodology and not drug efficacy, the shortest possible treatment period was selected to minimize patient burden.

### Wash-Out Duration

No washout period is scheduled prior to the first stage (Training stage). The Training stage will last approximately 4 weeks, and it is unreasonable to request participants to be on no treatment during that period. Participants will be asked only to refrain from taking any analgesic dose for 12 hours prior to their in-clinic training visits.

Prior to randomization into the Training Evaluation stage, participants on daily doses of an analgesic will have a 3 to 5 day washout period. A 3-day minimum washout was selected based on at least 5 half-lives of common NSAIDS (e.g., naproxen has a systemic half-life of 12-14 hours), and the 5-day maximum is to allow scheduling flexibility for participants in starting a treatment arm. An identical washout period (3-5 days) between treatment periods will allow adequate time for washout from pregabalin (half-life of only 6 hours).

### 2. STUDY OBJECTIVES

### 2.1. Primary Objective

To compare the ability of EPT and DPA training to increase subjects' ability to discriminate between active and placebo treatments in a double-blind crossover trial of a known analgesic, measured by standardized effect size, relative to untrained control subjects.

### 2.2. Secondary Objectives

To evaluate whether baseline characteristics of subjects predict response to training, measured by differences in psychophysical profile between baseline and end of study.

### 3. STUDY ENDPOINTS

The study endpoints are:
Primary Endpoint 1 (Treatment Efficacy): Difference between treatment arms (pregabalin vs. placebo in Training Evaluation stage) in change from baseline 0-10 NRS current pain intensity.
Primary Endpoint 2 (Training Efficacy): Difference between treatment arms (pregabalin vs. placebo in Training Evaluation stage) and between training conditions (EPT, DPA training, and C) in change from baseline 0-10 NRS current pain intensity.
Safety Endpoint: Adverse events (AEs) reported.
Secondary Endpoints:
   Change from baseline 0-10 NRS 24-hour worst and average pain intensity
   Quality of life (QoL)
   Patient Global Impression of Change (PGIC)
   Patient Preference for Treatment
   Presence or absence of allodynia (from brief sensory exam)
   Change from baseline in psychophysical function variables
      Pressure pain threshold and tolerance
      Perceptual power function intercept and slope exponent
      Evoked pain report reliability (coefficient of variation [CoV])

### 4. STUDY DESIGN

This is an investigator-initiated, exploratory, single-center, double-blind, randomized, placebo-controlled, crossover study of pregabalin versus placebo to evaluate methods of training participants to improve study assay sensitivity. The duration of participation will be up to 64 days. Eligible participants will have chronic pain as a result of diabetic neuropathy. After meeting initial entry criteria participants will be randomized to one of three parallel training conditions, EPT, DPA, or Control (“Training stage”). Participants in the EPT group will undergo 4 weeks of in-clinic training using the EPT paradigm in 4 sessions spaced approximately 1 week apart. In EPT participants will repeatedly rate an evoked pain delivered via pressure to the thumbnail and receive feedback. Participants in the DPA group will be administered randomized, double-blind, single-doses of placebo (twice), pregabalin (once), and oxycodone (once) in-clinic, rate their experience, and be unblinded after treatment. The C group will have an approximately 4-week delay during which no special training will be administered. After the Training stage, there will be a 3- to 5-day wash-out from existing therapy if necessary (participants not on any medications will not need a wash-out). At the end of the wash-out period, participants will need to have a minimum pain score of at least 4/10 to be randomized into the Treatment Evaluation stage, which is a 2-period crossover study. After baseline assessments, they will be treated in a double-blinded fashion with either pregabalin or placebo for at least 10 days, including a 3-4 day titration period (pregabalin 150 mg/day) and a 7-day stable treatment period (pregabalin 300 mg/day) with 1 50-mg capsule (titration) or 2 50-mg capsules (stable treatment) three times a day (tid). At the end of Treatment Period A, participants will have a 3- to 5-day wash-out period followed by 10- to 11-day Treatment Period B with the alternate treatment following the same procedure.

### 5. STUDY POPULATION

### 5.1. Number of Participants

Up to 105 participants will be randomized to the training conditions, intending 30 per arm with up to 5 replacements allowed for dropouts from each training condition. Participants who discontinue early after being randomized to treatment in the Training Evaluation stage will not be replaced.

### 5.2. Duration of Study

Participants will be in the study for up to a maximum of 64 days, a period that includes an approximately 4-week training period, 7-day wash-out, 10-11-day treatment (Treatment Period A), a second 7-day wash-out, and a 10-11-day treatment (Treatment Period B).

### 5.3. Number of Study Centers

One clinical center is planned.

### 5.4. Eligibility Criteria

5.4.1. Inclusion Criteria

A subject must meet all of the following criteria to be enrolled in the study:
1. Male or a non-pregnant, non-lactating female 18 years or older. Women of childbearing potential should be willing to use an acceptable birth control method (at the Investigator's discretion) during the study to avoid pregnancy.
2. Have voluntarily provided written informed consent (see attached ICF described herein).
3. Be able to speak, read, write, and understand English, understand the consent form, complete study-related procedures, and communicate with the study staff.
4. Have a clinical diagnosis of Painful Diabetic Neuropathy (PDN) for at least 6 months.
   a. Clinical diagnosis may be verified by medical records or by clinical examination during the first visit combined with a medical history of appropriate symptoms for at least 6 months.
5. Have a pain intensity score averaging ≧4 on a 0-10 NRS for average daily recall over past 24 hours.
6. Be, in the opinion of the Investigator, in sufficiently good health to participate in the study at screening, based upon the results of a medical history, physical examination and laboratory analysis.
   After the first wash-out period prior to Treatment Period A, the participants must meet the following additional criteria for randomization: Have in-clinic pain intensity (24-hour recall) ≧4 on the 0-10 NRS.

5.4.2. Exclusion Criteria

A subject must be excluded if any of the following criteria are met:
1. Are pregnant and/or lactating.
2. Have been diagnosed as having any inflammatory arthritis, gout, pseudo-gout, Paget's disease, fibromyalgia or any chronic pain syndrome that in the Investigator's opinion would interfere with the assessment or self-evaluation of pain and other symptoms of PDN.
3. Have evidence for multiple causes of pain in the neuropathic pain area, such as lumbar radiculopathy.
4. As-needed use of NSAID compounds (oral or topical) within 1 week of study and for the duration of the study (stable doses are allowable).
5. Have used opioids (including tramadol), within 1 week of study and for the duration of the study, or pregabalin, or gabapentin within 2 weeks of the study and for the duration.
   1. Other medications such as antidepressants for the treatment of depression and insult for treatment of diabetes are allowed, provided that the doses have been stable for at least 1 month prior to Visit 1 and are expected to be stable for study duration.
   2. Sliding scale insulin is considered stable so long as it is consistently used within parameters specified by a treatment plan.
   3. Medications used on an as-needed basis for non-pain conditions are allowable if taken on a stable dose (e.g. as-need anti-anxiety medication).
6. Have used prescription capsaicin 8% patch (e.g., Qutenza®) within 3 months. (Over-the-counter topical capsaicin creams [0.025% and 0.075%] are not excluded.)
7. Have had neuro-ablation or neurosurgical intervention for their PDN.
8. Have received nerve block or intrathecal analgesia within 6 weeks of study.
9. Have a history of congestive heart failure, unstable coronary artery disease, stroke, or uncontrolled hypertension.
10. Have a history of significant gastrointestinal disease, including active gastro-duodenal ulcerations, perforations, or bleeds.
11. Have abnormal clinical laboratory test results or vital signs unless deemed not clinically significant by the investigator.
12. Have regularly worn false fingernails within the past 6 months (more than 25% of the time)
13. Are undergoing active treatment for cancer, are known to be infected by human immunodeficiency virus, or are being acutely and intensively immunosuppressed following transplantation.
14. Have a history of alcohol or other substance abuse (not including nicotine or tobacco) within 5 years.
15. Have a history of suicide attempt within the past 1 year or suicidal ideation within the past 1 month.
16. Have a history of epilepsy or other seizure disorder.
17. Have creatinine clearance below 60 mL/min as calculated by Cockroft-Gault equation for serum creatinine.
18. Known to have a condition that in the Investigator's judgment precludes participation in the study.
19. Have received an investigational drug or have used an investigational device in the 30 days prior to study entry.
20. Have previously been admitted to this study.
21. Are involved in an ongoing or settled worker's compensation claim, disability, or litigation
22. Have a known failure to respond to pregabalin, gabapentin, or oxycodone due to either efficacy or tolerability in previous treatment.
23. Are allergic to or have a hypersensitivity to pregabalin or oxycodone.

In addition to the exclusions above, the following medications are excluded:
During the Training stage, participants may not take any non-acetaminophen analgesic 24 hours before a training session visit. Acetaminophen must not be taken 12 hours before a training session visit. As-needed analgesics as well as stable doses of analgesics are allowed at all other times during the Training stage. At the end of the Training stage, participants will be instructed to terminate any analgesic excluded in the Training Evaluation stage.
During the Training Evaluation stage, participants may not take an NSAID, non-study opioid, or nonstudy alpha-2-delta ligand. Protocol-specified rescue acetaminophen, up to 2 g/day, is allowed except for 12 hours before a training session visit. Participants may remain on stable doses of a tricyclic antidepressant or selective serotonin-norepinephrine reuptake inhibitor (SSNRI), provided doses have been stable for at least 1 month prior to the initiation of the Training Evaluation stage (Visit 2).
During the entire study, participants may remain on stable doses (at least 1 month) of any non-analgesic medication, provided dose remains stable throughout the study. Insulin dosed on a sliding scale is allowed, as long as insulin is consistently used within parameters specified by a treatment plan.

### 6. STUDY PROCEDURES

Time and Events Schedule of Procedures is tabulated in Table 2 and detailed below, divided by study stage.

TABLE 2
Time and Events Schedule of Procedures

| Study Period | Screening/Baseline |
|---|---|
| Visit | V1 |
| Clinic visit (C) or telephone call (T) | C |
| Study day(s) ^{a} | 1 |
| Informed consent | X |
| Inclusion/exclusion criteria | X |
| Urine pregnancy dipstick test | X |
| Medical history/demographics/ | X |
| previous treatment experience | |
| Vital signs (BP & HR) | X |
| General physical exam | X |
| Blood draw | X |
| Focused Analgesia Selection | X |
| Task (FAST) | |
| Randomization to training condition | X |

| | |
|---|---|
| | Training |
| Study Period | Evoked Pain Training (EPT) |

| Visit | T1 | T2 | T3 | T4 |
|---|---|---|---|---|
| Clinic (C) or telephone | C | C | C | C |
| (T) | | | | |
| Study day(s) ^{a, c} | 2 to 8 | 9 to 15 | 16 to 22 | 23 to 29 |
| MAST pressure training | X | X | X | X |
| and feedback | | | | |

| | |
|---|---|
| | Training |
| Study Period | Drug/Placebo Administration (DPA) |

| Visit | T1 | T2 | T3 | T4 |
|---|---|---|---|---|
| Clinic (C) or telephone | C | C | C | C |
| (T) | | | | |
| Study day(s) ^{a,} ^{c} | 2 to 8 | 9 to 15 | 16 to 22 | 23 to 29 |
| 0-10 NRS Current Pain (at | X | X | X | X |
| hours 0, 2 and 4) | | | | |
| PGIC (at hours 2 and 4) | X | X | X | X |
| Vital signs (BP & HR, hours | X | X | X | X |
| 0, 2, 4) | | | | |
| Unblind Treatment, discuss | X | X | X | X |
| with patient (after all other | | | | |
| assessments at hour 4) | | | | |
| Treatment | 1 capsule | 1 capsule | 1 capsule | 1 capsule |
| AE assessment (hours 2 and 4) | X | X | X | X |

| Study Period | Training |
|---|---|
| Visit | Control (C) |
| Clinic (C) or telephone | No additional training - rollover into Training |
| (T) | |
| Study day(s) ^{a} | Evaluation Stage after 28-day waiting period. ^{a} |
| | 2 to 29 |

| | | Treatment A | | | | | | Treatment B | | | | |
|---|---|---|---|---|---|---|---|---|---|---|---|---|
| | | Begin | | Tolera- | | End | | Begin | | Tolera- | | End |
| | | Treat- | | bility | | Treat- | | Treat- | | bility | | Treat- |
| Study Period | Wash- | ment | Titra- | check | Stable | ment | Wash- | ment | Titra- | check | Stable | ment |
| Visit | out ^{b} | V2 | tion | V3 | Dose | V4 | out | V5 | tion | V6 | Dose | V7 |
| Clinic (C) or Telephone | | C | | T | | C | | C | | T | | C |
| (T) | | | | | | | | | | | | |
| Study Day(s) ^{a} | 30 to | 37 | 37 to | 39 or | 40 to | 46 | 47 to | 54 | 54 to | 56 or | 57 to | 64 ^{d} |
| | 36 | | 39 | 40 | 46 | | 53 | | 56 | 57 | 63 | |
| Randomization | | X | | | | | | | | | | |
| Pain intensity NRS | | X | | | | X | | X | | | | X |
| items | | | | | | | | | | | | |
| QoL | | X | | | | X | | X | | | | X |
| Brief Sensory Exam | | X | | | | X | | X | | | | X |
| (Allodynia) | | | | | | | | | | | | |
| PGIC | | | | | | X | | | | | | X |
| Patient Global Prefer- | | | | | | | | | | | | X |
| ence for Treatment | | | | | | | | | | | | |
| Treatment | | | 1 | | 2 | | | | 1 | | 2 | |
| | | | capsule | | capsules | | | | capsule | | capsules | |
| | | | tid | | tid | | | | tid | | tid | |

| | |
|---|---|
| AEs assessment | <--- Throughout Study ---> |
| Concomitant medications | <--- Throughout Study ---> |

^{a} All Training Evaluation study days are estimated, plus or minus 1 day to allow subject scheduling flexibility
^{b} Subjects not requiring washout (no medications being discontinued) prior to Treatment Period A may skip washout period prior to Treatment A
^{c} EPT and DPA sessions will be scheduled 1 per week for 4 weeks; timing is flexible but visits must be separated by 7 +/−3 days (min. 4, max 10)
^{d} Maximum study duration is 64 days. Total duration may be shorter for subjects not requiring wash-out or scheduling training sessions at minimum intervals.

### 6.1. Screening—Visit 1 (Day 1)

Participant recruitment will be conducted by the Investigators and/or staff at the clinical site. Potential participants will be recruited by local advertising approved by the Institutional Review Board (IRB). During the screening and recruitment process, the Investigators will be responsible for describing the nature of the clinical study, verifying that the eligibility criteria have been met, and obtaining informed consent.

The following specific procedures will be conducted and documented:

6.1.1. Informed Consent

All participants will provide written informed consent for the study prior to collection of study data or performance of study procedures/treatments. An written informed consent form (ICF) is provided.

6.1.2. Assignment of Subject Number

To de-identify participants' information, a unique identification number will be given to all participants who provide written informed consent.

All participants who provide informed consent will be given a 5-digit number. The first 2 digits will be the clinical site number, with 01 being clinical site 1. The last 3 digits will be numbers of 001 to 999 assigned in ascending sequential order during the screening visit.

6.1.3. Eligibility

The subject's eligibility for study enrollment will be reviewed and documented on the appropriate case report form (CRF) and will include the following:
Demographic Information: The participant's demographic information will be documented on the appropriate CRF and will include date of birth, gender, height, weight, body mass index (BMI) (calculated), race, and ethnicity.
Previous Study and Treatment Experience: The number of previous clinical drug studies that the participant has been treated in, the total duration of time spent in such studies, and the number of previous drug treatments used to treat PDN (in clinical studies or outside of studies) will be recorded.
Medical History: Recent and relevant medical history will be obtained for the past 3 years.
Prior and Concomitant Medications: All medications currently being taken and those taken within the past year will be documented as completely as possible.
Non-fasted Clinical Laboratory Tests: Blood samples for serum chemistry, hematology, and coagulation and a random urine sample for urinalysis will be collected. The following tests will be performed by the local laboratory.
   Hematology Panel

| | |
|---|---|
| Hemoglobin | White blood cell count with differential |
| Hematocrit | Platelet count |
| Red blood cell count | Percent reticulocytes |

Coagulation Panel
   Prothrombin time
   Activated partial thromboplastin
Serum Chemistry Panel

| | |
|---|---|
| Sodium | Alkaline phosphatase |
| Potassium | Creatine phosphokinase |
| Chloride | Lactic acid dehydrogenase |
| Bicarbonate | Uric acid |
| Blood urea nitrogen | Calcium |
| Creatinine | Phosphate |
| AST | Albumin |
| ALT | Total protein |
| Gamma-glutamyltransferase | Magnesium |
| Total bilirubin | |

Urinalysis by Dipstick

| | |
|---|---|
| Specific gravity | pH |
| Glucose | Protein |
| Blood | Ketones |
| Bilirubin | Urobilinogen |
| Nitrite | Leukocyte esterase |

Urine Drug Screen
Pregnancy Test
Physical Examination: A brief physical exam will be conducted, and the PDN diagnosis confirmed. The study Investigator or authorized designee (who must be a physician, physician's assistant or nurse practitioner) will perform the physical examinations. Height and body weight will be measured at Screening Visit 1 only.
Vital Signs: Sitting blood pressure and heart rate measurements will be assessed with a completely automated device consisting of an inflatable cuff and an oscillatory detection system. All values will be registered on a built-in recorder so that measurements are observer independent. Blood pressure and heart rate measurements will be assessed while the subject is in the sitting position. Manual blood pressure readings may be obtained in the event of instrument malfunction.

All enrollment criteria will be reviewed to ensure that participants meet all inclusion and none of the exclusion criteria to the extent possible. Note: laboratory values may be reviewed at the next visit.

6.1.4. Clinical Pain Intensity

All participants will be asked to rate the following on a 0 to 10 NRS scale, where 0 is “No Pain” and 10 is “Extreme Pain”:
Current Pain Intensity from PDN
Average Pain Intensity from PDN in the past 24 hours
Worst Pain Intensity from PDN in the past 24 hours

6.1.5. Focused Analgesia Selection Task (FAST)

All participants who meet all preliminary entry criteria will undergo the FAST assessment procedures as described in Appendix 9.1. Note: No feedback or training will be provided after the psychophysical assessment portion.

6.1.6. Neurosensory Function Assessment

Participants meeting all preliminary entry criteria will be evaluated for small fiber function using the Small Fiber Neurological Examination of the Lower Extremities as described in an Appendix 9.2 herein.

6.1.7. Training Assignment

For participants who meet all entry criteria and are randomized into the training stage of the study, a training condition number will be assigned and will consist of 3 digits, 001 to 105. Training condition numbers will be assigned sequentially, except in the instance of replacements for dropouts, who will be sequentially assigned to the replacement condition numbers; numbers 091 to 095 will be replacements for EPT dropout, 096 to 100 will be replacements for DPA dropouts, and 101 to 105 will be replacements for C dropouts. Note: Participants who discontinue the study during the training stage but prior to treatment randomization will be replaced up to a maximum of five (5) participants in each training condition. Participants discontinuing after treatment randomization will not be replaced and the sixth or subsequent participants discontinuing during a training condition will not be replaced.

For each training condition number 001 to 090, the assignment to training condition (EPT, DPA, or C) will have been determined in accordance with the pre-determined randomization scheme prior to study start. This will have been done in blocks to ensure that approximately equal numbers of participants are assigned to the 3 training conditions on an ongoing basis. There will be 30 participants in each of the three training conditions. Replacement training condition numbers 91 through 105 will be fixed as described above. Assignment to training condition is NOT blinded. The participant and Investigator will know which training condition the participant is assigned to.

6.2. Evoked Pain Training Condition—Visits T1 through T4 (Days 2 through 29) Participants assigned to the EPT condition will be scheduled for 4 training visits. For simplification of visit schedules between training and control conditions training visits will be designated Visits T1 through T4. Training visits will be scheduled approximately 1 week apart with the following conditions:
Visit T1 (first training visit) must be at least 1 day after Screening
Visits must be at least 4 days apart, but not more than 10 days apart
   Participants will be instructed not to take any analgesic medications for 24 hours prior to each training visit.

6.2.1. Evoked Pain Training

At each training visit (T1 through T4) participants assigned to the EPT condition will undergo EPT as described in Appendix 9.3, including threshold and tolerance assessment, rating of index pain, and psychophysical profiles with feedback.

During the 3-4 week EPT period participants will be allowed to continue the use of any medications allowed under the study inclusion/exclusion criteria. This includes the use of as-needed (prn) analgesics, including opioids, provided that the participant takes no analgesic medication for 24 hours prior to each EPT session. (It is considered important that the participant not be under the immediate effect of analgesics during the actual training session, but there is no reason to subject them to the burdens of abstaining from their usual medications between sessions during the entire training period.)

### 6.3. Drug/Placebo Administration Training—Visits T1 Through T4 (Days 2 Through 29)

Participants assigned to the DPA condition will be scheduled for 4 training visits. For simplification of visit schedules between training and control conditions training visits will be designated Visits T1 through T4. Training visits will be scheduled approximately 1 week apart with the following conditions:
Visit T1 (first training visit) must be at least 1 day after Screening
Visits must be at least 4 days apart, but not more than10 days apart

Participants will be instructed not to take any prn analgesic medications for 24 hours prior to each training visit. The use of concomitant medications allowed by the study inclusion/exclusion is permitted, as is prn medication outside of the 24 hour pre-visit window.

6.3.1. DPA Treatment Randomization

At the first DPA training visit (T1) participants assigned to the DPA condition will be randomized to a treatment sequence for their DPA treatments. Note: this is distinct and fully independent from their treatment assignment in the Training Evaluation stage of the study. A DPA treatment assignment number will be assigned at the first DPA training visit, T1. DPA participants will be assigned a two digit DPA sequence number sequentially from 01 to 35. For each DPA sequence number the assignment to treatment sequence will have been determined in accordance with the pre-determined randomization scheme prior to study start. Treatment sequences will be randomly determined orders of four treatments, oxycodone 15 mg, pregabalin 150 mg, and two placebo treatments. Note: participants will have been informed that they will be receiving a randomly assigned series of four treatments that may include oxycodone, pregabalin, or placebo. They will not have been told how many of each treatment are in the sequence in order to minimize their ability to determine the content of their last treatment by process of elimination.

6.3.2. Pre-Treatment Assessments

6.3.3. Vital Signs:

Sitting blood pressure and heart rate measurements will be assessed with a completely automated device consisting of an inflatable cuff and an oscillatory detection system. All values will be registered on a built-in recorder so that measurements are observer independent. Blood pressure and heart rate measurements will be assessed while the subject is in the sitting position. Manual blood pressure readings may be obtained in the event of instrument malfunction.

6.3.4. Clinical Pain Intensity:

All participants will be asked to rate the following on a 0 to 10 NRS scale, where 0 is “No Pain” and 10 is “Extreme Pain”:
Current Pain Intensity from PDN
Average Pain Intensity from PDN in the past 24 hours
Worst Pain Intensity from PDN in the past 24 hours

6.3.5. DPA Training Stage Treatment

Authorized clinical staff will remove the assigned treatment medication from the blister pack. Participant will self-administer the medication under supervision of the clinic staff Δt 2 hours and 4 hours post-treatment vital signs will be taken and participants will rate their Current Pain Intensity from PDN on the 0-10 NRS.

6.3.6. Post-Treatment Assessment and Feedback

Six hours after treatment vital signs will be taken a final time and participants will:
Rate Current Pain Intensity from PDN on the 0-10 NRS
Rate PGIC
Answer the Treatment Experience Questionnaire (see Appendix 9.4)

After providing ratings, the clinic staff will partially unblind the treatment just received to the participant, telling them whether the treatment was an active drug or a placebo. The specific treatment will not be unblinded, only whether it was active or placebo. Clinic staff will then review the participant's responses to the Treatment Experience Questionnaire with the participant with particular attention paid to the reasons why the participant believed they received drug/placebo. For example, if the participant believed they received active drug because of a perceived side effect but actually had placebo, the clinician might emphasize to the participant that it is possible to experience side effects even when on placebo. Conversely, if the participant is confident that they received active drug because they experienced meaningful pain relief after actually receiving active drug, this strategy would be endorsed.

Note: All reasonable efforts will be made to prevent the clinic staff or participants from being unblinded to treatment prior to intentional unblinding, particularly by process of elimination at the final visit. To this end, participants will not be told how many of each type of treatment they will be receiving, only that during the DPA training they will be given a randomized sequence that may include pregabalin, oxycodone, and placebo. Records of previous visits' unblinding will not be apparent in the materials available to the clinic staff during the visit. Whenever possible the end-of-visit unblinding and debrief will be conducted by different clinical staff members such that no one person unblinds a participant at all four DPA training visits. It is acknowledged that the double-blind during DPA training may not be perfect. For example, a single clinic staff member sees a given participant at all four visits due to scheduling issues and might conceivably remember that the participant's previous three visits included only one placebo and conclude that the final visit must be a placebo as well. However, since the blinding for DPA training sessions is not critical for any test of drug safety or efficacy this is considered acceptable.

### 6.4. Control Training Condition

Participants assigned to the C condition for training will receive no training and will not make any in-clinic training visits corresponding to T1 through T4 as EPT and DPA condition participants do.

Participants in the C condition may proceed to the Training Evaluation stage beginning with the wash-out period immediately. Note that even if the participant is not on any medications requiring wash-out prior to beginning Treatment Period A, V2 should not be scheduled prior to confirmation of all eligibility criteria including creatinine clearance.

### 6.5. Wash-Out

After completing all training visits (no visits for C participants) participants will enter a 7-day wash-out period. During the washout period no prn analgesic medication is allowed excepting acetaminophen as rescue medication up to 2 g/day and not for 12 hours prior to Visit 2. Concomitant medications taken as part of a consistent regimen that is allowed by the inclusion/exclusion criteria should be continued (e.g. allowed daily antidepressants or regular use of insulin to manage diabetes).

### 6.6. Visit 2 (Begin Treatment Period A)

Note: Training Evaluation stage begins with Visit 2. Participants withdrawing from the study prior to Visit 2 may be replaced, up to 5 in each training condition. Participants withdrawing or discontinued from the study at Visit 2 or later will not be replaced.

6.6.1. Review of Eligibility Criteria

Review all inclusion/exclusion criteria, including the following:
Vital signs
In-clinic pain NRS (24-hour recall) to ensure subject meets minimum pain requirements

Participants, who meet all eligibility for randomization, including minimum pain intensity scores, will continue in the study. Those who fail to meet these eligibility criteria will be discontinued and will not be replaced.

6.6.2. Treatment Randomization

For participants who continue to meet all criteria and are randomized into the Training Evaluation stage of the study, a treatment number will be assigned and will consist of 2 digits, 01 to 90. Treatment condition numbers will be assigned sequentially as participants enter the Training Evaluation stage. Forty-five (45) participants will be assigned pregabalin as Treatment A with placebo as Treatment B and 45 participants will have placebo as Treatment A with pregabalin as Treatment B. Within each treatment order 15 participants will have come from each of the three training conditions, as shown in Table 3 Training/Treatment Randomization.

TABLE 3
Training/Treatment Randomization

Treatment Condition (A-B)

| Training Condition | Pregabalin-Placebo | Placebo-Pregabalin |
|---|---|---|
| EPT | n = 15 | n = 15 |
| DPA | n = 15 | n = 15 |
| C | n = 15 | n = 15 |

Note that the 2-digit treatment number assigning the pregabalin/placebo sequence for the training evaluation stage (cross-over) is not to be confused with the 3-digit training condition number assigning EPT/DPA/C condition (parallel).

6.6.3. Baseline a Assessments

6.6.4. Vital Signs

Blood pressure and heart rate measurements will be assessed while the subject is in the sitting position in the same manner as at Visit 1.

6.6.5. Pain Intensity

All participants will be asked to rate the following on a 0 to 10 NRS scale, where 0 is “No Pain” and 10 is “Extreme Pain”:
Current Pain Intensity from PDN
Average Pain Intensity from PDN in the past 24 hours
Worst Pain Intensity from PDN in the past 24 hours

6.6.6. Quality of Life (QoL) Measure

All participants will complete the SF-36 QoL measure. The acute (1-week recall) version will be used (see Appendix 9.5).

6.6.7. Neurosensory Function Assessment

Participants will be evaluated for small fiber function using the Small Fiber Neurological Examination of the Lower Extremities as described in Appendix 9.2 herein.

6.6.8. Dispensing of Study Medication

Study medications for Treatment Period A will be dispensed according to the assigned randomization number. The study drugs will consist of capsules packaged in blister packages labeled for morning, mid-day and evening doses. Sufficient doses will be provided on each blister card for up to 4 days' titration at 1 capsule tid followed by 8 days of stable dosing at 2 capsules tid to allow for some flexibility in scheduling. The capsules for both pregabalin and placebo will be identical looking, and both placebo and pregabalin will be packaged in identical-looking blister cards. The blister cards will contain no identifying information other than subject number, Treatment Period designation (A or B), and dosing instructions.

6.6.9. Dosing

Participants will be provided with Treatment Period A study medications for their treatment randomization number.
Initial Dosing: The first dose of study medications is to be taken in the clinic after completion of all procedures for Visit 2. The subject will be instructed to take the evening doses for that day at least 6 hours later.
Dosing Schedule: Dosing during the treatment periods will be three times per day dosing (tid). Dosage will be 1 capsule per dose during the titration period until tolerability is confirmed at Visit 3. After Visit 3 dosage will increase to 2 capsules per dose.
Methods of Administration: All doses will be taken orally with a small glass of water or milk. The capsules may be taken with food. Participants should be informed that if they feel nauseated after taking the dose, their subsequent doses should be taken with food or milk.

6.6.10. Participant Instructions

Participants will be provided with dosing instructions and especially reminded not to increase dosing to 2 capsules until directed to (Visit 3 tolerability check). Participants will be instructed that they are allowed to take acetaminophen as rescue medication up to 2 g/day maximum. Participants will be reminded not to take rescue acetaminophen for at least 12 hours before the next visit.

### 6.7. Visit 3 (Tolerability Check)

Visit 3 is conducted by telephone at a scheduled time 2 to 3 days after Visit 2. Clinic staff will contact the participant by telephone to confirm tolerability of study medication. If the participant is tolerating the medication acceptably well they will be instructed to begin dosing with 2 capsules tid for 7 days. If the participant is not tolerating medication they may be withdrawn at this point due to non-tolerability at the Investigator's discretion.

### 6.8. Visit 4 (End of Treatment Period A)

Visit 4 will be scheduled 10 days after Visit 2. Participants will return to the clinic to be evaluated for the end of Treatment A.

6.8.1. End of Treatment a Assessments

6.8.2. Vital Signs

Blood pressure and heart rate measurements will be assessed while the subject is in the sitting position in the same manner as at Visit 1.

6.8.3. Pain Intensity

All participants will be asked to rate the following on a 0 to 10 NRS scale, where 0 is “No Pain” and 10 is “Extreme Pain”:
Current Pain Intensity from PDN
Average Pain Intensity from PDN in the past 24 hours
Worst Pain Intensity from PDN in the past 24 hours

6.8.4. Quality of Life (QoL) Measure

All participants will complete the SF-36 QoL measure. The acute (1-week recall) version will be used (see Appendix 9.5).

6.8.5. Neurosensory Function Assessment

Participants will be evaluated for small fiber function using the Small Fiber Neurological Examination of the Lower Extremities as described in Appendix 9.2 herein.

6.8.6. PGIC

Participants will provide a rating of Patient Global Impression of Change (PGIC) from the beginning of Treatment A to the end of Treatment A.

### 6.9. Wash-Out

After completing Treatment Period A (i.e., at the end of Visit 4) participants will enter another 7-day washout period prior to Treatment Period B. During the wash-out period no prn analgesic medication is allowed excepting acetaminophen as rescue medication up to 2 g/day and not for 12 hours prior to Visit 5. Concomitant medications allowed during the previous washout period should be continued in the same fashion.

### 6.10. Visit 5 (Begin Treatment Period B)

Visit 5 to begin Treatment Period B will be scheduled 7 days after Visit 4. Visit procedures are identical to Visit 3.

6.10.1. Review of Eligibility Criteria

Review all inclusion/exclusion criteria, including the following:
Vital signs
In-clinic pain NRS (24-hour recall) to ensure subject meets minimum pain requirements

Participants, who meet all eligibility for randomization, including minimum pain intensity scores, will continue in the study. Those who fail to meet these eligibility criteria will be discontinued and will not be replaced.

6.10.2. Baseline B Assessments

6.10.3. Vital Signs

Blood pressure and heart rate measurements will be assessed while the subject is in the sitting position in the same manner as at Visit 1.

6.10.4. Pain Intensity

All participants will be asked to rate the following on a 0 to 10 NRS scale, where 0 is “No Pain” and 10 is “Extreme Pain”:
Current Pain Intensity from PDN
Average Pain Intensity from PDN in the past 24 hours
Worst Pain Intensity from PDN in the past 24 hours

6.10.5. Quality of Life (QoL) Measure

All participants will complete the SF-36 QoL measure. The acute (1-week recall) version will be used (see Appendix 9.5).

6.10.6. Neurosensory Function Assessment

Participants will be evaluated for small fiber function using the Small Fiber Neurological Examination of the Lower Extremities as described in Appendix 9.2 herein.

6.10.7. Dispensing of Study Medication

Study medications for Treatment Period B will be dispensed according to the assigned randomization number. The study drugs will consist of capsules packaged in blister packages labeled for morning, mid-day, and evening doses. Sufficient doses will be provided on each blister card for up to 4 days' titration at 1 capsule tid followed by 8 days of stable dosing at 2 capsules tid to allow for some flexibility in scheduling. The capsules for both pregabalin and placebo will be identical looking, and both placebo and pregabalin will be packaged in identical-looking blister cards. The blister cards will contain no identifying information other than subject number, Treatment Period designation (A or B), and dosing instructions.

6.10.8. Dosing

Participants will be provided with Treatment Period B study medications for their treatment randomization number.
Initial Dosing: The first dose of study medications is to be taken in the clinic after completion of all procedures for Visit 5. The subject will be instructed to take the evening doses for that day at least 6 hours later.
Dosing Schedule: Dosing during the treatment periods will be three times per day dosing (tid). Dosage will be 1 capsule per dose during the titration period until tolerability is confirmed at Visit 6. After Visit 6 dosage will increase to 2 capsules per dose.
Methods of Administration: All doses will be taken orally with a small glass of water or milk. The capsules may be taken with food. Participants should be informed that if they feel nauseated after taking the dose, their subsequent doses should be taken with food or milk.

6.10.9. Participant Instructions

Participants will be provided with dosing instructions and especially reminded not to increase dosing to 2 capsules until directed to (Visit 6 tolerability check). Participants will be instructed that they are allowed to take acetaminophen as rescue medication up to 2 g/day maximum. Participants will be reminded not to take rescue acetaminophen for at least 12 hours before the next visit.

### 6.11. Visit 6 (Tolerability Check)

Visit 6 is conducted by telephone at a scheduled time 2 to 3 days after Visit 5. Clinic staff will contact the participant by telephone to confirm tolerability of study medication. If the participant is tolerating the medication acceptably well they will be instructed to begin dosing with 2 capsules tid for 7 days. If the participant is not tolerating medication they may be withdrawn at this point due to non-tolerability at the Investigator's discretion.

### 6.12. Visit 7 (End of Treatment Period B, End of Study)

Visit 7 will be scheduled 10 days after Visit 5. Participants will return to the clinic to be evaluated for the end of Treatment B and conclusion of the study.

6.12.1. End of Treatment B Assessments

6.12.2. Vital Signs

Blood pressure and heart rate measurements will be assessed while the subject is in the sitting position in the same manner as at Visit 1.

6.12.3. Pain Intensity

All participants will be asked to rate the following on a 0 to 10 NRS scale, where 0 is “No Pain” and 10 is “Extreme Pain”:
Current Pain Intensity from PDN
Average Pain Intensity from PDN in the past 24 hours
Worst Pain Intensity from PDN in the past 24 hours

6.12.4. Quality of Life (QoL) Measure

All participants will complete the SF-36 QoL measure. The acute (1-week recall) version will be used (see Appendix 9.5).

6.12.5. Neurosensory Function Assessment

Participants will be evaluated for small fiber function using the Small Fiber Neurological Examination of the Lower Extremities as described in Appendix 9.2 herein.

6.12.6. PGIC

Participants will provide a rating of PGIC from the beginning of Treatment B to the end of Treatment B.

6.12.7. Patient Global Preference for Treatment

Participants will answer a Patient Global Preference for Treatment question indicating which of the two treatments (Period A or Period B) they preferred.

6.12.8. FAST or Psychophysical Profile

Participants will complete the FAST assessment procedures as described in Appendix 16.2. Note: No feedback or training will be provided after the psychophysical assessment portion.

6.13. Withdrawal and/or Early Termination Procedures

No follow-up visits will be scheduled, but participants with clinically significant AEs should be followed until satisfactory resolution.

A subject can be withdrawn from the study at the discretion of the Investigator for medical reasons or if the subject wishes to terminate the study. If a subject does not return for a scheduled visit, every effort should be made to contact the subject and to document the subject outcome, if possible.
Participants are considered lost to follow-up if they do not return to the office for scheduled visits to complete the study. Documentations of attempts to contact the subject must be included on the End of Study Form.

### 6.14. Unblinding of Subject Treatment

In the case of a medical emergency or in the event of a serious medical condition (such as a serious AE [an SAE]) when knowledge of the investigational product is essential for the clinical management or welfare of the subject, the Principal Investigator or other physician managing a study subject may decide to unblind that subject's treatment code. The Investigator will record the date and reason for revealing the blinded treatment assignment for that subject in the appropriate CRF form.

### 7. STATISTICAL METHODS

### 7.1. Study Hypothesis

(a) There will be a greater difference between placebo and pregabalin for participants in the EPT condition than those in the C condition.
(b) There will be a greater difference between placebo and pregabalin for participants in the DPA condition than those in the C condition.
(c) The difference between placebo and pregabalin will not be significantly different between those participants in the EPT condition and those in the DPA condition.

Additionally, given the exploratory nature of the study we anticipate evaluating without formal hypotheses which, if any, baseline participant characteristics are predictive of change in pain reporting characteristics (from psychophysical profile) for each training group.

### 7.2. Study Populations

Safety Population: This population will include all participants who receive at least 1 dose of study drug (placebo or pregabalin).

Per-protocol Population: The per-protocol population will include all participants who complete the 2 treatment periods without major protocol violation.

### 7.3. Sample Size

Ninety (90) participants will be randomized to the training evaluation stage, with up to 15 replacements allowed during the training stage. Assuming a moderate effect size of pregabalin in PDN of 0.35² a paired-comparison t-test between means (placebo vs. pregabalin) with alpha=0.05 and power=0.90 power analysis yields a sample size requirement of N=88. A sample of N=90 allows for convenient balancing of assigned conditions and treatment orders to six cells (3 training conditions and 2 treatment orders). ²This is slightly lower than some published studies to allow a margin for the short treatment period.

Given the exploratory nature of the training programs, the effect size of any difference between groups is unknown. Therefore we did not calculate the power and sample size for detecting statistically significant between-subject differences between the three conditions. Groups will be compared on their respective effect sizes in discriminating pregabalin from placebo and in paired comparisons of difference between treatments.
Additionally, the interaction term of an analysis of variance (ANOVA) for 3 conditions by 2 treatments will provide a test of whether training group interacted with the difference between conditions. If we assume testing for marginal significance in this exploratory work (alpha=0.10) and a Cohen's f of 0.15 (a medium effect for this measure) this sample of N=90 in 3 groups with 2 measurements provides a power of approximately 0.80.

### 7.4. Randomization and Blinding

Randomization will be used to avoid bias in the assignment of participants to training condition and treatment sequence and to increase the likelihood that known and unknown subject attributes (e.g., demographic and baseline characteristics) are evenly balanced across the different design cells. Blinded treatment will be used to reduce potential bias during data collection and evaluation of clinical endpoints. During the double-blind period of the study, the subject and all personnel involved with the conduct and the interpretation of the study, including the Investigators, study center personnel, and the Sponsor (or designee) staff, will be blinded to the medication codes. Randomization data will be kept strictly confidential, filed securely by the Sponsor (or designee), and accessible only to authorized persons per Sponsor's (or designee's) standard operating procedures until the time of unbinding. In the event that an emergency unblinding is required, authorized/approved randomization system users, at the study centers and Sponsor (or designee), will have the ability to retrieve subject treatment groups assignment through the randomization system. Unblinding a subject should only be done in emergency situations for reasons of subject safety. The Investigator/study center should make every attempt to contact the Sponsor's or designee's Medical Monitor before breaking the blind. When the blinding code is broken, the reason must be fully documented in the source documentation.

### 7.5. Data Analysis

7.5.1. General Considerations for Efficacy Analysis

All efficacy analyses will be performed for all participants who complete the study without major protocol violations. Unless otherwise specified, all efficacy parameters will be presented by treatment group and by training condition group using summary statistics. Statistical analyses using analysis of variance (ANOVA) with repeated measures that are appropriate for cross-over design will be performed to compare treatments regarding efficacy endpoints. Additional between-subject variables for training condition will be used where appropriate. Analyses of efficacy endpoints will be 2-sided with significance level of 0.05.

7.5.2. Methodology to Achieve Study Objectives

### Primary Objective:

To compare the ability of Experimental Pain Training (EPT) and Drug/Placebo Administration (DPA) training to increase subjects' ability to discriminate between active and placebo treatments in a double-blind crossover trial of a known analgesic, measured by standardized effect size, relative to untrained control subjects.

### Secondary Objective:

To evaluate whether baseline characteristics of subjects predict response to training, measured by differences in psychophysical profile between baseline and end of study.

To Compare the Sensitivity of Participants in Different Training Conditions in Discriminating the Efficacy of Pregabalin Versus Placebo:

Two methods will be used to address the primary objective of determining whether either training condition (EPT or DPA) provides superior assay sensitivity compared to the control condition.

1). Standardized effect size (SES) for each training condition will be determined using Cohen's d formula for SES (delta between conditions divided by pooled standard deviation)³. The SES will be calculated and compared graphically and in table format for the 3 training conditions. ³Cohen's d is planned on the initial assumption that any differences between treatment sequences will not confound this measure. If there are differences between treatment sequences such that orders cannot be collapsed a modified equivalent of Cohen's d may be substituted if necessary.

2). We will examine the interaction term from a 3×2 repeated measures ANOVA using 2 treatment conditions (placebo/naproxen) as a within-subject independent variable and 3 training conditions (EPT/DPA/C) as a between-subjects independent variable. A significant interaction term will indicate that the difference between placebo and pregabalin is different across training conditions. Planned paired comparisons of treatment difference between each pair of training conditions will be conducted to identify specific pair differences and address the specific study hypotheses of difference between training conditions. If treatment sequences are not able to be collapsed due to significant differences, between order of treatment sequence (A-B/B-A) will be included as an additional between-subjects variable, making the ANOVA a 3×2×2.

To Identify Baseline Characteristics Predicting Response to Training:

Response to training will be quantified by the change in variables from the psychophysical profile conducted at baseline to the same scores at end of study. This will include CoV and function exponent.

1). Change in each variable will be used as the outcome in a multiple linear regression model (separate models for each variable). Participant characteristics at baseline will be entered into the model using a stepwise method (criteria will be specified in the statistical analysis plan, but most likely 0.05 to enter and 0.10 to exit the model) and assessed for significance. Final models will be reported for each variable. Baseline variables to be used as predictors are: age, sex, baseline pain (now, in past 24 h, worst pain in past 24 h), duration of PDN pain, duration of diabetes, and previous treatment experience (number of previous clinical studies, time in previous clinical studies, and number of previous treatments tried).

2). Identical multiple linear regression models will be constructed using the same predictor variables but using the psychophysical profile variables from the end of study visit. Using scores at end of study as opposed to change from baseline to end of study will provide an analysis of which baseline variables predict final reporting parameters as opposed to change. For example, some variables may predict change by being correlated with extreme baseline states and it may be useful to differentiate between predictors of final high report reliability and those that predict improvement in report reliability (i.e., those who were always reliable and so had little change and those who started with poor reliability and had room to improve a great deal).

3). Additional analyses will be conducted for subgroups of participants in the EPT and DPA training conditions:

3a). For participants who underwent EPT, regression models will be constructed analogous to those described above for the entire population but with the addition of psychophysical function variables at their final training visit (T4) and change in variables from baseline to T4 as predictors.

3b). For participants in the DPA condition, additional regression models will include as a possible predictor their accuracy, in %, of their discrimination between active treatment and placebo from the TEQ and their average confidence ratings from the TEQ.

3c). No additional models will be constructed for the control condition participants.

Additional psychophysical function variables, possibly including but not limited to function intercept, ICC, and R² fit to function curve may be analyzed in similar fashion as exploratory alternative endpoints for training response.

7.5.3. Safety Analyses

The safety analysis population includes participants who received at least 1 dose of study drug. The number and percentage of participants with AEs will be displayed by system organ class and preferred term using the Medical Dictionary for Regulatory Activities®. Summaries in terms of severity and relationship to study drug will also be provided. SAEs will be summarized separately in a similar manner. Subject listings of AEs causing discontinuation of study medication and SAEs will be produced.

Vital Signs: Vital signs analysis will include the mean, standard deviation, minimum, maximum, and quartiles at baseline and at the end of each treatment, and the change from baseline to the end of each treatment.

Clinical Laboratory: Laboratory parameters analysis will include the mean, standard deviation, minimum, maximum, and quartiles at baseline and at the end of each treatment, as well clinically significant shifts in laboratory values during each Treatment Period.

Concomitant Medications: Concomitant medications will be analyzed descriptively.

### 7.6. General Statistical Considerations

All statistical analysis will be performed using either SAS for Windows (version 9.2 or higher) or SPSS for Windows (version 19.0 or higher). Subject data listings and tabular presentation of results will be provided. Presentation of summary statistics for continuous variables will include N, mean, median, and standard deviation, as well as the minimum and maximum values. For categorical variables, the number and percentage of each category within a parameter for nonmissing data will be calculated. All clinically relevant baseline variables will be tabulated and compared between the 2 treatment groups and the 3 training condition groups. All statistical tests will be 2-sided unless otherwise stated, employing a significance level of 0.05. No adjustments for multiplicity will be made unless otherwise stated. All comparisons planned in the statistical analysis plan will be completed as specified, and fully reported.

Demographic and other baseline characteristics will be summarized. Medical history will be summarized by body system and by number and percentage of participants reporting the history.

Management of dropouts and missing data will depend on their frequency and the nature of the outcome measure. Analysis of the distribution of prognostic factors between participants with data and those without data will be reviewed for significance to assess selection bias. Adjustments for missing data will be performed only if deemed necessary and will be described completely in the statistical analysis plan.

Outlier values will be evaluated for their validity; all data will be included unless judged to be invalid.

### 8. REFERENCES

The following references are hereby incorporated by reference in their entireties:
Baumann M, Moffat G, Roberts L, Ward L. Constrained scaling: Achieving quantitative convergence across laboratories. Fechner Day 2004. Coimbra, Portugal: International Society for Psychophysics; 2004.
Fedele L, Marchini M, Acaia B, Garagiola U, Tiengo M. Dynamics and significance of placebo response in primary dysmenorrhea. Pain. 1989; 36:43-47.
Lesser M, Sharma U, LaMoreaux L, Poole R. Pregabalin relieves symptoms of painful diabetic neuropathy: A randomized controlled trial. Neurology. 2004; 63:2104-2110. LYRICA® (pregabalin) package insert. Pfizer, Inc. June 2012.
Quiton R, Greenspan J. Across- and within-session variability of ratings of painful contact heat stimuli. Pain. 2008:245-256.
Richter R, Portenoy R, Sharma U, Lamoreaux L, Bockbrader H, Knapp L. Relief of painful diabetic peripheral neuropathy with pregabalin: A randomized, placebo-controlled trial. The Journal of Pain. 2005; 6(4):253-260.
Rosenstock J, Ruchman M, LaMoreaux L, Sharma U. Pregabalin for the treatment of painful diabetic neuropathy: A double-blind, placebo-controlled trial. Pain. 2004; 110:628-38.

### 9. APPENDICES

### 9.1. FAST Assessment

The FAST procedure is a subject selection tool designed by Analgesic Solutions and consists of the following 2 parts: Psychological Assessment and Psychophysical Assessment.

Psychosocial Assessment: The Psychosocial Assessment consists of a series of psychological survey questions that will be presented to the participant, and participant responses will be collected as described in the FAST Instructions Manual. The participant will have as much time to answer each survey question as needed. The Psychosocial Assessment will consist of the surveys as detailed in the FAST Instructions Manual.

Psychophysical Assessment: Participants will be seated comfortably in a chair, and the study procedures will be explained. Participants will be familiarized with the Multimodal Automated Sensory Testing (MAST) system that applies precisely computer-controlled pressure stimuli to the thumbnail (see Appendix 9.9). The MAST device can apply pressure up to 10 kg/cm², which can be quite painful but does not cause lasting tissue damage. Participants may experience a temporary tenderness or sensitivity in the thumb, but this typically fades in less than a day. Participants will be told that they may ask questions, express concerns, or stop the procedure at any time by saying “stop,” and the Investigator will stop the procedure.

The participant will place the thumb of their non-dominant hand in the MAST handpiece, with the forearm supported (as by a table or the arm of a chair) and the arm bent comfortably.

The MAST device will apply an ascending series of stimuli to the thumbnail, beginning at 0.5 kg and increasing by 0.5 kg per trial with a pause between trials (interstimulus interval, or ISI) of 20 seconds. Pressure will be applied at a ramp rate of 4 kg per second and each stimulus will last approximately 5 seconds at peak pressure. The MAST device automatically self-calibrates the stimulus pressure to maintain a stable force profile across the stimulus. At the conclusion of the stimulus the participant will indicate the intensity of pain they experienced during the stimulus on a 0-10 NRS with 0 being “no pain” and 10 being “extreme pain” using the touch-screen client computer of the MAST system. The first pressure at which the participant reports non-zero pain is the pain threshold. Participants are explicitly instructed that ratings should be of pain, not pressure. Trials continue in increasing increments until the participant either gives a rating of maximum pain (10 out of 10) or indicates that they cannot tolerate higher pressure. This pressure is the pain tolerance. The participant may terminate any trial at any time with a simple on-screen button or by verbal communication to the experimenter.

The participant then completes a psychophysical profile procedure in which they rate, on the 0-10 NRS, a series of randomized stimuli between their threshold and tolerance levels. The psychophysical profile stimuli are at 6 evenly-spaced intervals beginning at the participant's threshold and ending at the last 0.5 kg increment prior to tolerance level. For example, for a participant with a threshold level of 2 kg and tolerance of 5 kg, intervals would be 2 kg, 2.5, 3.0, 3.5, 4.0, and 4.5. Each stimulus level is repeated 4 times for a total of 24 stimuli in randomized order with an ISI of 20 seconds.

If the subject needs to stop the procedure, he or she may touch the “STOP” button on the MAST client tablet or say “stop” aloud and the Investigator will stop the trial. Continuation of the psychophysical profile procedure will be at the discretion of participant and the Investigator, who will take into consideration the safety and best interests of the participant.

### 9.3. Evoked Pain Training (EPT)

Evoked pain stimuli will be pressure applied to the participants' thumbnail using the computer-controlled Multimodal Automated Sensory Testing (MAST) system.

Evoked pain training (EPT) consists of 4 stages: 1) assessment of pain threshold and pain tolerance using the MAST, 2) rating of PDN pain using traditional a NRS or VAS (whatever is specified in the protocol) and cross-modality matching to pressure pain using MAST, 3) ratings of randomized painful pressure stimuli, and 4) feedback on performance.
Evoked pain stimuli are delivered to the participants' thumbnail via the MAST system. The MAST system is a non-significant risk device which applies a computer-controlled pressure stimulus to the thumbnail at a precisely controlled intensity for a specified duration. The MAST consists of two touchscreen-enabled netbook or laptop computers, one an experimenter control console or server and the other a participant response or client that can display instructions and the participant uses to enter responses, and two handsets that can apply the thumbnail pressure stimulus (only one is used in the EPT procedure). The handset is a pistol-grip style unit with a slot that the participant inserts their thumb into. A rubber-tipped plunger depresses onto the participant's thumbnail with a specified pressure, self-adjusting to the resistance of the thumb and any movement to ensure a consistent pressure. A typical experiment using the MAST would apply a stimulus and then ask the participant to rate that stimulus on a VAS or NRS scale using the client console computer. A detailed description of the MAST safety features and risk assessment are included as Appendix 9.9 of this protocol.

Evoked Pain Training consists of 4 basic stages:

9.3.1. Assessment of Pain Threshold and Tolerance

The MAST device will apply an ascending series of stimuli to the thumbnail, beginning at 0.5 kg and increasing by 0.5 kg per trial with a pause between trials (interstimulus interval, or ISI) of 20 seconds. Pressure will be applied at a ramp rate of 4 kg per second and each stimulus will last approximately 5 seconds at peak pressure. The MAST device automatically self-calibrates the stimulus pressure to maintain a stable force profile across the stimulus. At the conclusion of the stimulus the participant will indicate the intensity of pain they experienced during the stimulus on a 0-10 NRS with 0 being “no pain” and 10 being “extreme pain” using the touch-screen client computer of the MAST system. The first pressure at which the participant reports non-zero pain is the pain threshold. Participants are explicitly instructed that ratings should be of pain, not pressure. Trials continue in increasing increments until the participant either gives a rating of maximum pain (10 out of 10) or indicates that they cannot tolerate higher pressure. This pressure is the pain tolerance. The participant may terminate any trial at any time with a simple on-screen button or by verbal communication to the experimenter.

9.3.2. Index Pain Assessment

Participants are asked to provide rating of their current PDN pain 1) using a 0-10 NRS and 2) by matching their current pain to evoked pressure pain using an ascending method of limits. The MAST will apply gradually increasing pressure to the thumbnail until the participant indicates that the pressure pain is of equal intensity to their PDN pain. This will be done 3 times and the scores averaged.

9.3.3. Random Magnitude Estimation

The primary evoked pain experience used in training is the repeated application and rating of randomly selected pressure stimuli. Stimuli will range from a minimum at the participant's pain threshold and to a maximum of the participant's pain tolerance. The psychophysical profile stimuli are at 6 evenly spaced intervals beginning at the participant's threshold and ending at the last 0.5 kg increment prior to tolerance level. For example, for a participant with a threshold level of 2 kg and tolerance of 5 kg, intervals would be 2 kg, 2.5, 3.0, 3.5, 4.0, and 4.5. Each stimulus level is repeated 4 times for a total of 24 stimuli in randomized order with an ISI of 20 seconds.

9.3.4. Training Feedback

After completing a cycle of magnitude estimations participants will receive feedback on their performance including discussion with the experimenter and possibly review a graphical representation of their responses. An example of a feedback figure is shown in 1 herein.

The 4 steps of EPT are repeated three times for a total of 4 training cycles per EPT session. There is a break between cycles of approximately 15 minutes. The first cycle is applied to the participant's dominant hand and subsequent cycles alternate between the dominant and non-dominant hands.

### 9.9. MAST System Safety Features and Risk Determination

9.9.1. MAST System Safety Features

The MAST handpiece employs several methods to avoid patient injury and maintain safety. These methods are categorized in three components of the system hierarchy, specifically mechanical, electrical and software.

### Mechanical Safety Features

The most fundamental safety features rely on the mechanical design of the device. Passive methods include the large, easily accessible mechanical power switch that is able to instantly remove all power to the device (including the motor). In conjunction with this, an aluminum shaft is connected to the pinion that drives the plunger. This shaft can be used to manually move the plunger and remove the force applied to the patient in the event of an electrical or control system failure. The motor and gear system has been selected so that it is physically unable to provide more than approximately 200N (approximately 20 kg/cm²) of force to the thumb, preventing severe and/or permanent tissue or bone damage.

### Electrical System Safety Features

On the electrical side, fuses have been included on the output of the battery to prevent excessive current flowing in the control circuitry and producing excessive heating. An absolute rotary encoder has been attached to the motor output shaft so that the position of the plunger is continuously monitored. If the plunger moves out of the hard-coded operating range, the power to the motor is immediately removed. This range has been set to ensure the motor will not drive the plunger all the way to the bottom of the testing area. In addition, a load cell has been integrated into the plunger and measures the force directly applied 50 times per second. If the command force is exceeded by 25N, the testing is immediately terminated and the plunger retracted. There are also additional internal limits that can be set to limit the maximum power delivered to the motor and hence the maximum force that can be applied. Due to the nature of these limits, they are inherently less accurate than the load cell, but they provide additional safety in the unlikely event of the load cell under-reporting the applied force and the controller continually applying more power to try to achieve the set point.

### Software Safety Features

The device has also been designed to independently control each stimulus interval. This means that the controlling computer will set up the required parameters for the stimulus (i.e., force and duration) and give a “go” command that will be transmitted to the handpiece via a Bluetooth link. The device will then have full control of the stimulus application until it is complete. This is done to prevent lost or corrupted communications interfering with the force profile applied to the patient. Besides the inherent error detection built-in to the Bluetooth protocol, the device will echo any received commands back to the controlling computer, so that the validity of test parameters can be verified prior to starting a stimulus. However, Bluetooth operates in the unlicensed 2.4 GHz ISM frequency range and a Frequency Hopping (FH) algorithm is used to ensure the link is robust to interference. In the event of a situation requiring the test be stopped, the computer software can send a terminate stimulus command that will immediately cause the plunger to retract.

We claim:

1. A method of training a subject to accurately report a clinical symptom, the method comprising:
a) administering to a subject exhibiting a clinical symptom a drug suitable for treating the clinical symptom or a placebo, wherein the drug is administered in an amount sufficient to alleviate the clinical symptom;
b) determining the intensity of the clinical symptom reported by the subject before and after administration of the drug or the placebo using a standard reporting scale;
c) determining the symptom reporting accuracy of the subject in the presence of the drug or placebo and providing instructional feedback to the subject regarding the accuracy and reliability of their reporting; and
d) repeating steps (a) to (c) one or more times, wherein on each occasion the subject is administered drug or placebo in a random and double-blind manner.

2. The method of claim 1, wherein step (d) is repeated until a desired reporting accuracy is achieved.

3. The method of claim 1, wherein steps (a) to (c) are repeated four times at weekly intervals.

4. The method of claim 1, wherein steps (a) to (c) are performed for 4 hours and the subject evaluated hourly for clinical symptom relief.

5. The method of claim 1, further comprising identifying an accurate symptom reporting subject, wherein an accurate symptom reporting subject is identified by having a symptom reporting accuracy and/or reliability above a desired threshold.

6. The method of claim 1, wherein the clinical symptom is pain, anxiety, asthma, or urinary frequency.

7. The method of claim 6, wherein the pain is Painful Diabetic Neuropathy (PDN).

8. The method of claim 1, wherein the drug is oxycodone or pregabalin.

9. A method of training a subject to accurately report a clinical symptom, the method comprising:
a) inducing a clinical symptom in the subject;
b) determining the intensity of the clinical symptom reported by the subject using a standard reporting scale;
c) determining the symptom reporting accuracy of the subject and providing instructional feedback to the subject regarding the accuracy and reliability of their reporting; and
d) repeating steps (a) to (c) one or more times.

10. The method of claim 9, wherein step (d) is repeated until a desired reporting accuracy is achieved.

11. The method of claim 9, further comprising identifying an accurate symptom reporting subject, wherein an accurate symptom reporting subject is identified by having a symptom reporting accuracy and/or reliability above a desired threshold.

12. The method of claim 9, wherein the clinical symptom is pain, anxiety, asthma, or urinary frequency.

13. The method of claim 12, wherein the pain is Painful Diabetic Neuropathy (PDN).

14. A method of training a subject to accurately report a clinical symptom, the method comprising:
a) determining the reported pain threshold and tolerance levels of the subject in response to an evoked pain stimulus;
b) determining the response profile of the subject to noxious stimuli using a standard pain reporting scale in the presence of an analgesic or a placebo, wherein the noxious stimuli intensity are between the pain threshold and tolerance levels of the subject, and wherein the analgesic is administered in an amount sufficient to alleviate the pain induced by the noxious stimuli;
c) determining the pain reporting accuracy and/or reliability of the subject by analysis of the data collected in (a) and (b);
d) providing instructional feedback to the subject regarding the accuracy and reliability of their pain reporting; and
e) repeating steps (a) to (e) one or more times, wherein on each occasion the subject is administered the analgesic or the placebo in a random and double-blind manner.

15. The method of claim 14, wherein step (e) is repeated until a desired reporting accuracy is achieved.

16. The method of claim 14, further comprising identifying an accurate symptom reporting subject, wherein an accurate symptom reporting subject is identified by having a symptom reporting accuracy and/or reliability above a desired threshold.

17. The method of claim 14, wherein the clinical symptom is pain, anxiety, asthma, or urinary frequency.

18. The method of claim 17, wherein the pain is Painful Diabetic Neuropathy (PDN).

19. The method of claim 14, wherein the drug is oxycodone or pregabalin.

20. The method of claim 14, wherein the pain threshold and tolerance levels of the subject are determined in response to a mechanical pressure or thermal stimulus.

21. The method of claim 14, wherein the noxious stimuli include mechanical pressure.

22. The method of claim 14, wherein the noxious stimuli are applied in a random order of intensity.

23. The method of claim 14, wherein the noxious stimuli are applied in discreet interval levels, evenly spaced between the subject's threshold and tolerance levels.

24. The method of claim 23, wherein the noxious stimuli are applied in 5 to 9 interval levels.

25. The method of claim 23, wherein each interval level of noxious stimuli is applied between 3 and 7 times to the subject during a single session.

26. The method of claim 14, wherein the standard pain reporting scale is a numerical rating scale (NRS) or visual analog scale (VAS).

27. The method of claim 14, wherein the pain reporting accuracy and/or reliability of the subject is determined using a the Coefficient of Variation, Intraclass Correlation Coefficient, R² curve fit statistic from a least squares fit to psychophysical function, and/or the Residual between the predicted and actual pain ratings using a ‘triangulation’ method.

28. The method of claim 16, wherein an accurate pain reporting subject is identified by having a Coefficient of Variation of less than 1, an Intraclass Correlation Coefficient of greater than 0.8, an R² of greater than 0.5, and/or a triangulation residual of less than 20% of the range of the response scale being used.
